(19) United States
(12) Patent Application Publication
(10) Pub. No.: US 2025/0126615 A1
(43) Pub. Date: Apr. 17, 2025

(54) UE-INITIATED OPERATIONS

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/900,418

(22) Filed: Sep. 27, 2024

Related U.S. Application Data
(60) Provisional application No. 63/543,824, filed on Oct. 12, 2023.

(51) Int. Cl. H04W 72/1268; H04W 72/232

(52) U.S. Cl. CPC H04W 72/1268; H04W 72/232

(57) ABSTRACT

Methods and apparatuses for user equipment (UE)-initiated operations. A method performed by a UE includes receiving first information related to a scheduling request (SR) for transmission of a beam report, receiving second information related to transmission of the beam report, and determining, based on the first information, a first uplink (UL) resource for transmitting the SR. The method further includes determining, based on at least the second information, a second UL resource for transmitting the beam report, transmitting, based on the first UL resource, the SR, and transmitting, based on the second UL resource, the beam report. The second information includes an indicator indicating that the second UL resource is dynamically scheduled or configured by radio resource control (RRC).

### CROSS-REFERENCE TO RELATED AND CLAIM OF PRIORITY

The present application claims priority under 35 U.S.C. § 119 (e) to U.S. Provisional Patent Application No. 63/543,824 filed on Oct. 12, 2023, which is hereby incorporated by reference in its entirety.

### TECHNICAL FIELD

The present disclosure relates generally to wireless communication systems and, more specifically, the present disclosure relates to methods and apparatuses for user equipment (UE)-initiated operations.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated operations.

In one embodiment, a UE is provided. The UE includes a transceiver configured to receive first information related to a scheduling request (SR) for transmission of a beam report and receive second information related to transmission of the beam report. The UE further includes a processor operably coupled with the transceiver. The processor is configured to determine, based on the first information, a first uplink (UL) resource for transmitting the SR and determine, based on at least the second information, a second UL resource for transmitting the beam report. The transceiver is further configured to transmit, based on the first UL resource, the SR and transmit, based on the second UL resource, the beam report. The second information includes an indicator indicating that the second UL resource is (i) dynamically scheduled or (ii) configured by radio resource control (RRC).

In another embodiment, a base station is provided. The base station includes a transceiver configured to transmit first information related to a SR for transmission of a beam report and transmit second information related to transmission of the beam report. The base station further includes a processor operably coupled with the transceiver. The processor is configured to determine, based on the first information, a UL resource for reception of the SR and determine, based on at least the second information, a second UL resource for reception of the beam report. The transceiver is further configured to receive, based on the first UL resource, the SR and receive, based on the second UL resource, the beam report. The second information includes an indicator indicating that the second UL resource is dynamically scheduled or configured by RRC.

In yet another embodiment, a method performed by a UE is provided. The method includes receiving first information related to a SR for transmitting a beam report, receiving second information related to transmitting the beam report, and determining, based on the first information, a UL resource for transmitting the SR. The method further includes determining, based on at least the second information, a second UL resource for transmitting the beam report, transmitting, based on the first UL resource, the SR, and transmitting, based on the second UL resource, the beam report. The second information includes an indicator indicating that the second UL resource is dynamically scheduled or configured by RRC.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a table of an example mapping between scheduling request (SR) settings and channel state information (CSI) resource configurations according to embodiments of the present disclosure;

FIG. 8 illustrates a flowchart of an example procedure for transmitting CSI/beam report(s) on physical uplink control channel (PUCCH) resource(s) according to embodiments of the present disclosure; and

FIG. 9 illustrates a flowchart of an example procedure for transmitting beam report(s) on uplink resource(s) according to embodiments of the present disclosure.

### DETAILED DESCRIPTION

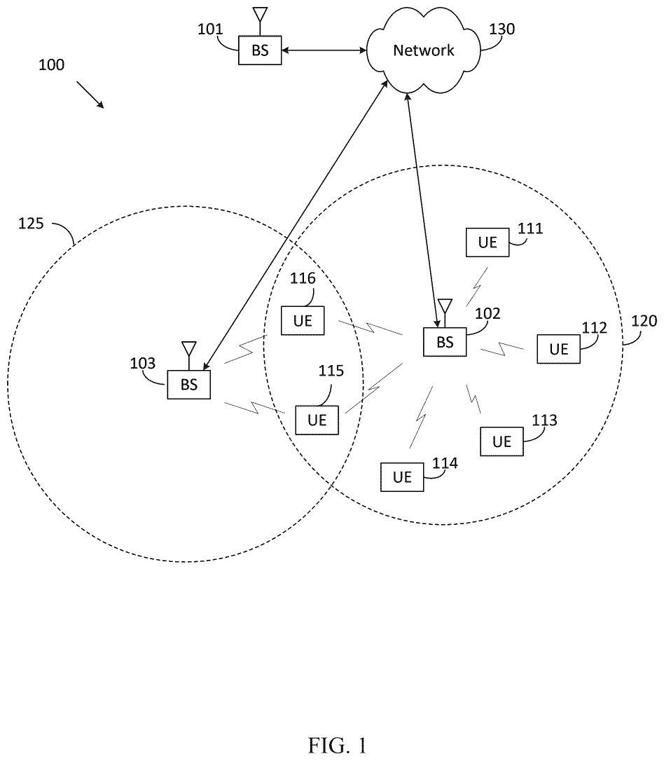

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to perform UE-initiated operations. In certain embodiments, one or more of the BSs 101-103 include circuitry, programing, or a combination thereof to support or enable UE-initiated operations.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

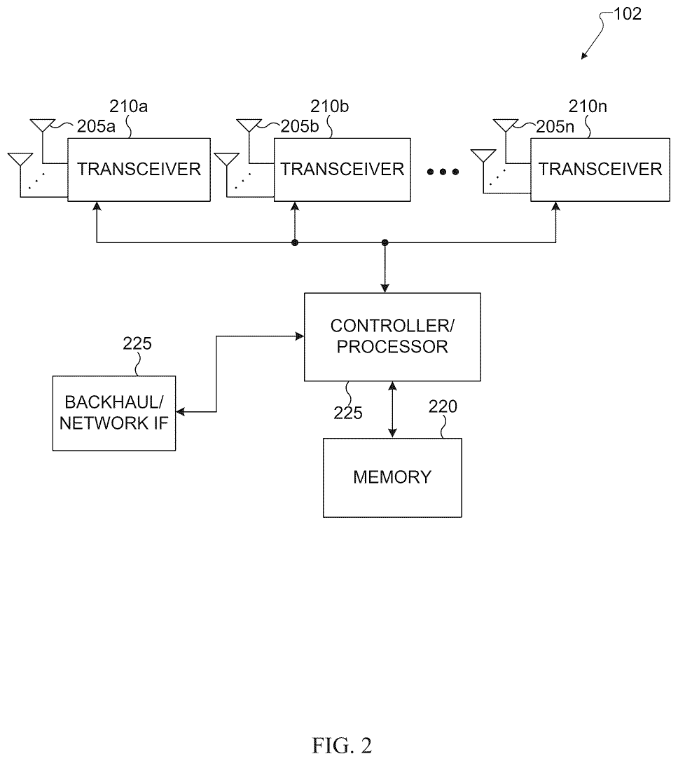

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling UE-initiated operations. Any of a wide variety of other functions could be supported in the gNB 102 by the controller/processor 225.

The controller/processor 225 is also capable of executing programs and other processes resident in the memory 230, such as supporting or enabling UE-initiated operations. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

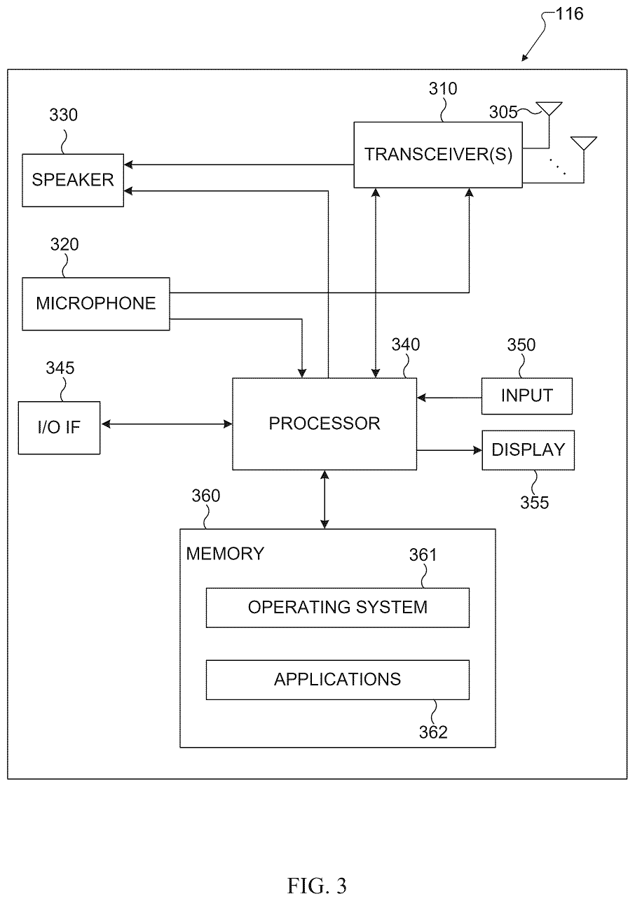

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UE-initiated operations as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

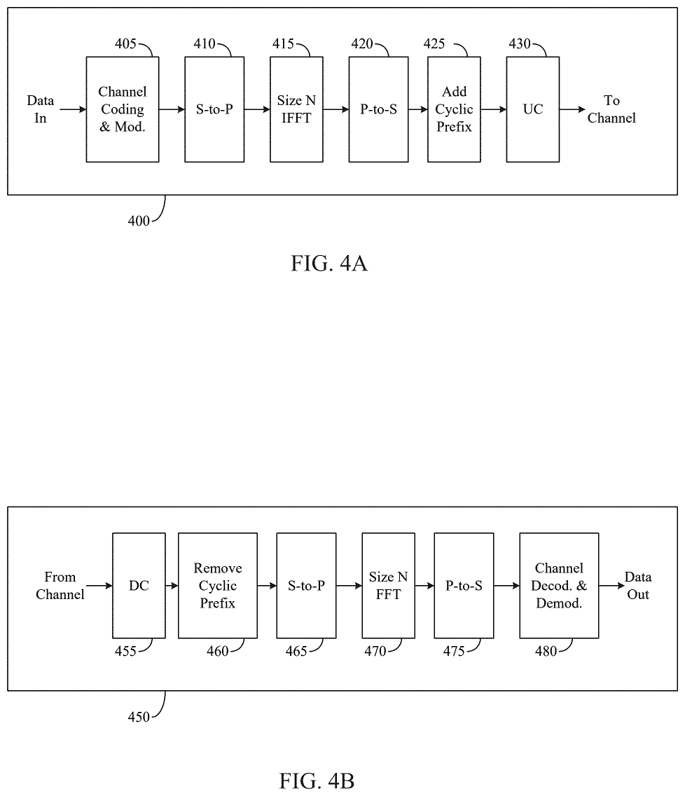

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to support UE-initiated operations as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

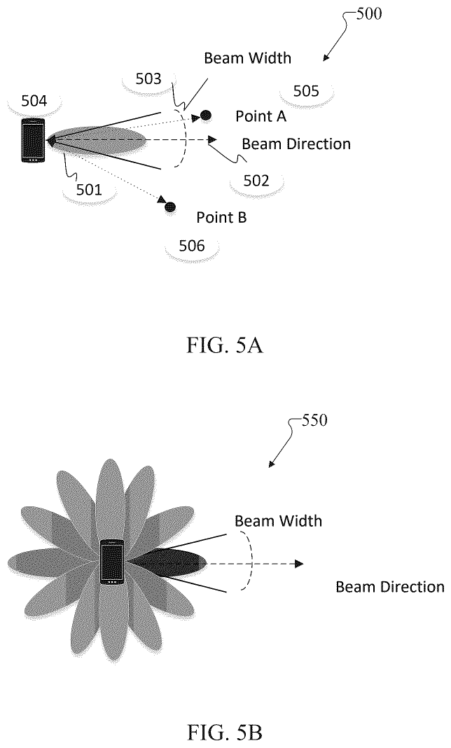

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by gNB 102 of FIG. 2. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

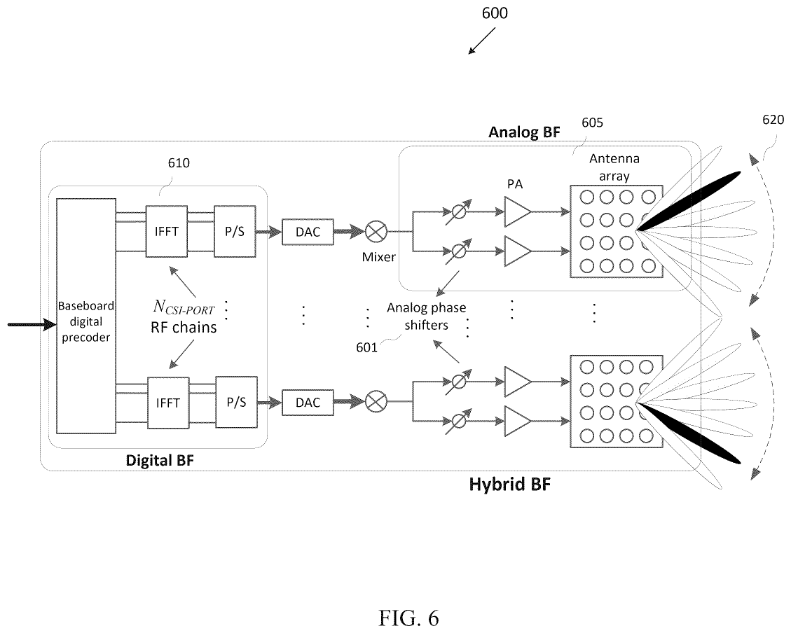

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mm Wave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NOSI-PORT. A digital beamforming unit 610 performs a linear combination across NOSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In this disclosure, a beam is determined by either of:
A TCI state, that establishes a quasi-colocation (QCL) relationship between a source reference signal (e.g. SSB and/or CSI-RS) and a target reference signal.
A spatial relation information that establishes an association to a source reference signal, such as SSB or CSI-RS or SRS.

In either case, the ID of the source reference signal identifies the beam. The TCI state and/or the spatial relation reference RS can determine a spatial Rx filter for reception of downlink channels at the UE, or a spatial TX filter for transmission of uplink channels from the UE.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In (up to Rel. 17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE (e.g. the UE 116) knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, embodiments of the present disclosure recognize that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate). This disclosure provides example embodiments on the mentioned UE-initiated beam management framework including CSI/beam reporting, beam switching and beam activation/sub-selection. Furthermore, this disclosure also provides various design options for triggering and/or requesting beam(s) measurement/reporting, beam(s) activation/deactivation/sub-selection and/or beam(s) switching, and/or requesting uplink (UL) resource(s) for sending information/content(s) related to the beam(s) measurement/reporting, beam(s) activation/deactivation/sub-selection and/or beam(s) switching under the UE-initiated and/or event-based beam management framework.

The present disclosure provides various embodiments for UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents detailed methods of how to trigger/request beam(s)/TCI state(s) measurement/reporting/activation/switching—e.g., via/in a form of a scheduling request (SR)—and the corresponding uplink resource(s) for sending/transmitting information or content(s) related to the UE-initiated and/or even-based beam operations.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, synchronization signal block resource indicator (SSBRI)) and Jᵢ is a beam metric (e.g. layer 1 reference signal received power (L1-RSRP), layer 1 signal-to-interference-plus-noise ratio (L1-SINR)).
In one example, the content includes CSI-related quantity/quantities. For example, at least one of (rank indicator (RI), precoding matrix indicator (PMI), channel quality indicator (CQI), CQI report interval (CRI), layer index (LI)).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 sidelink (SL)), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-) type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre-notification | |
| Event type | Type | message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related | No |
| | | event) | |
| | (B) | No | Yes |
| | (C) | Yes (e.g. TDCP-related | Yes |
| | | event) | |
| 3: non-CSI/beam/TDCP | (A) | Yes (e.g. non-CSI-related | No |
| | | event) | |
| | (B) | No | Yes |
| | (C) | Yes (e.g. non-CSI-related | Yes |
| | | event) | |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), content-specific or | No |
| | event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one embodiment, a UE could send to the network (e.g. the network 130) one or more indicators, e.g., in form of a scheduling request (SR), to indicate, initiate or trigger (i) periodic, semi-persistent and/or aperiodic CSI-RS(s) measurement and/or reporting, (ii) TCI state(s)/beam(s) activation/sub-selection/deactivation, and/or (iii) TCI state(s)/beam(s) switching/change. For instance, for the TCI state(s)/beam(s) switching/change, the one or more indicators, e.g., in form of a SR, could indicate, initiate or trigger update(s)/change(s) of one or more beams and/or transmission configuration indication (TCI) states (and therefore, quasi-co-location (QCL) settings including QCL source RS(s) and the corresponding QCL type(s) provided/configured therein) and/or spatial relation settings for receiving/transmitting one or more DL/UL channels and/or signals. Throughout this disclosure, a TCI state can also be referred to as a beam or a spatial relation setting; i.e., they can be used/applied to various design examples throughout the present disclosure interchangeably; for instance, a spatial relation or spatial relation setting for determining an UL Tx spatial filter can be with a reference to an RS in the indicated TCI state. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. Whether the one or more indicators, i.e., the SR, sent by the UE is to indicate, initiate or trigger (i) periodic, semi-persistent and/or aperiodic CSI-RS(s) measurement and/or reporting, (ii) TCI state(s)/beam(s) activation/sub-selection/deactivation, and/or (iii) TCI state(s)/beam(s) switching/change, could be according to one or more of the followings.
In one example, when/if the UE is provided/configured/indicated by the network, e.g., via higher layer RRC signaling(s)/parameter(s) and/or MAC control element (CE) command(s) and/or dynamic downlink control information (DCI) based L1 signaling(s), that the UE-initiated/triggered CSI-RS(s) measurement and/or reporting—as specified herein in the present disclosure—is enabled—e.g., the UE is provided/configured/indicated by the network, e.g., via/in the higher layer parameter CSI-ReportConfig, a higher layer parameter ‘ueInitiatedBeamReporting’ set to ‘enabled’ and/or reportQuantity set to one or more of: cri-RSRP, ssb-index-RSRP, cri-SINR, ssb-index-SINR, none, ueInitiatedBeamReporting, the one or more indicators, i.e., a/the SR, sent by the UE could be to indicate, initiate or trigger the CSI-RS(s) measurement and/or reporting.
In another example, when/if the UE is provided/configured/indicated by the network, e.g., via higher layer RRC signaling(s)/parameter(s) and/or MAC CE command(s) and/or dynamic DCI based L1 signaling(s), that the UE-initiated/triggered TCI state(s)/beam(s) activation/deactivation/sub-selection—as specified herein in the present disclosure—is enabled—e.g., the UE is provided/configured/indicated by the network, e.g., via/in the higher layer parameter CSI-ReportConfig, a higher layer parameter ‘ueInitiatedBeamActivation’ set to ‘enabled’ and/or reportQuantity set to one or more of: cri-RSRP, ssb-index-RSRP, cri-SINR, ssb-index-SINR, none, ueInitiatedBeamActivation, the one or more indicators, i.e., a/the SR, sent by the UE could be to indicate, initiate or trigger the TCI state(s) activation/sub-selection/deactivation.
In yet another example, when/if the UE is provided/configured/indicated by the network, e.g., via higher layer RRC signaling(s)/parameter(s) and/or MAC CE command(s) and/or dynamic DCI based L1 signaling(s), that the UE-initiated/triggered TCI state(s)/beam(s) switching/change/update—as specified herein in the present disclosure—is enabled—e.g., the UE is provided/configured/indicated by the network, e.g., via/in the higher layer parameter CSI-ReportConfig, a higher layer parameter ‘ueInitiatedBeamSwitching’ set to ‘enabled’ and/or reportQuantity set to one or more of: cri-RSRP, ssb-index-RSRP, cri-SINR, ssb-index-SINR, none, ueInitiatedBeamReporting, the one or more indicators, i.e., a/the SR, sent by the UE could be to indicate, initiate or trigger the TCI state(s)/beam(s) switching/change.
In yet another example, one or more first SRs (or SR IDs) or one or more first SR configurations (or SR configuration IDs) could be associated to/with or could be used to indicate/trigger/initiate P/SP/AP CSI-RS measurement and/or reporting as specified herein in the present disclosure, e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s).
   For example, the SR that is transmitted/received the first/last in time—e.g., among one or more transmitted/received SRs, and/or the K≥1 SRs that are transmitted/received the first/last in time—e.g., among one or more transmitted/received SRs, wherein the value of K could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the SR with the lowest/highest SR ID—e.g., among one or more SRs, and/or the L≥1 SRs with the highest/lowest SR IDs—e.g., among one or more SRs, wherein the value of L could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the SR(s) with odd SR ID(s), and/or the SR(s) with even SR ID(s), and/or the SR associated/corresponding to the SR configuration with the lowest/highest SR configuration ID—e.g., among one or more SR configurations/SR configuration IDs, and/or the M≥1 SRs associated/corresponding to the SR configurations with the lowest/highest SR configuration IDs—e.g., among one or more SR configurations/SR configuration IDs, wherein the value of M could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the SR(s) associated/corresponding to the SR configuration(s) with odd SR configuration ID(s), and/or the SR(s) associated/corresponding to the SR configuration(s) with even SR configuration ID(s), could correspond to the one or more first SRs (or SR IDs) used to indicate/trigger/initiate P/SP/AP CSI-RS measurement and/or reporting as specified herein in the present disclosure.
   For another example, the SR configuration with the lowest/highest SR configuration ID—e.g., among one or more SR configurations/SR configuration IDs, and/or the M≥1 SR configurations with the lowest/highest SR configuration IDs—e.g., among one or more SR configurations/SR configuration IDs, wherein the value of M could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the SR configuration(s) with odd SR configuration ID(s), and/or the SR configuration(s) with even SR configuration ID(s), could correspond to the one or more first SR configurations (or SR configuration IDs) used to indicate/trigger/initiate P/SP/AP CSI-RS measurement and/or reporting as specified herein in the present disclosure.
   Yet for another example, an indicator/configuration could be provided/indicated/configured in the higher layer parameter, e.g., SchedulingRequestConfig, that configures a SR—i.e., a SR configuration; for this case, when/if the indicator/configuration is set to ‘1’ (or ‘0’) or ‘00’ (or ‘01’, ‘10’, ‘11’) or ‘enabled’ (or ‘disabled’) or ‘ueInitiatedBeamReporting’, the corresponding/associated SR/SR configuration could be for indicating/initiating/triggering the P/SP/AP CSI-RS(s) measurement and/or reporting—i.e., a first SR/first SR configuration—as specified herein in the present disclosure. The described/specified indication/configuration herein could also be provided/indicated/configured by the network, e.g., via MAC CE command(s) and/or dynamic DCI based L1 signaling(s) associated/corresponding to a SR or a SR configuration.
   Yet for another example, a bitmap could be provided/indicated/configured in the higher layer parameter, e.g., SchedulingRequestConfig, that configures a SR—i.e., a SR configuration; at least an entry/bit position of the bitmap could be associated/corresponding to the UE-initiated/triggered P/SP/AP CSI-RS measurement and/or reporting; the entry(s)/bit position(s) of the bitmap associated/corresponding to the UE-initiated/triggered P/SP/AP CSI-RS measurement and/or reporting could be determined according to: (i) fixed value(s) in system specification(s)—e.g., the first or the last, (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., via/in part of a CSI/beam report and/or UE's capability signaling(s). For this case, when/if the entry(s)/bit position(s) of the bitmap is set to ‘1’ (or ‘0’), the corresponding/associated SR/SR configuration could be for indicating/initiating/triggering the P/SP/AP CSI-RS(s) measurement and/or reporting—i.e., a first SR/first SR configuration—as specified herein in the present disclosure.
   Yet for another example, the UE could be provided/indicated/configured by the network, e.g., via higher layer RRC signaling(s)/parameter(s) and/or MAC CE command(s) and/or dynamic DCI based L1 signaling(s), a set/list of one or more SR IDs and/or SR configuration IDs. For this case/design example, the SR(s) and/or the SR configuration(s) associated/corresponding to the provided/indicated/configured SR ID(s) and/or SR configuration ID(s) could be for indicating/initiating/triggering the P/SP/AP CSI-RS(s) measurement and/or reporting—i.e., the first SR(s)/first SR configuration(s)—as specified herein in the present disclosure.
   Yet for another example, the UE could be provided/indicated/configured by the network, e.g., via higher layer RRC signaling(s)/parameter(s) and/or MAC CE command(s) and/or dynamic DCI based L1 signaling(s), a bitmap with each entry/bit position of the bitmap associated/corresponding to a SR ID or a SR configuration ID; for this case/design example, when/if an entry/bit position of the bitmap is set to ‘1’ (or ‘0’), the corresponding/associated SR ID or SR configuration ID (and therefore, the corresponding SR or SR configuration) could be for indicating/initiating/triggering the P/SP/AP CSI-RS(s) measurement and/or reporting—i.e., a first SR/first SR configuration—as specified herein in the present disclosure. Alternatively, the UE could be provided/indicated/configured by the network, e.g., via higher layer RRC signaling(s)/parameter(s) and/or MAC CE command(s) and/or dynamic DCI based L1 signaling(s), one or more indicators each associated/corresponding to a SR ID or a SR configuration ID; for this case/design example, when/if an aforementioned indicator is set to ‘1’ (or ‘0’) or ‘enabled’ (or ‘disabled’) or ‘ueInitiatedBeamReporting’ or ‘00’ (or ‘01’, ‘10’, ‘11’), the corresponding/associated SR ID or SR configuration ID (and therefore, the corresponding SR or SR configuration) could be associated/corresponding to a first SR and used to indicate/trigger/initiate P/SP/AP CSI-RS(s) measurement and/or reporting—i.e., a first SR/first SR configuration—as specified herein in the present disclosure.
   Yet for another example, a SR sent by the UE could also indicate whether the SR could be used for indicating/initiating/triggering the P/SP/AP CSI-RS(s) measurement and/or reporting, i.e., whether the SR is a first SR as specified herein in the present disclosure. For instance, a SR sent by the UE could be a one-bit indicator; when/if the SR (or equivalently, the one-bit indicator) is set to ‘1’ (or ‘0’), the SR could be for indicating/initiating/triggering the P/SP/AP CSI-RS(s) measurement and/or reporting, i.e., the SR is a first SR as specified herein in the present disclosure. Alternatively, a SR sent by the UE could be a multi-bit or multi-level indicator—e.g., a 2-bit indicator; when/if the SR (or equivalently, the two-bit indicator) is set to ‘00’ (or ‘01’, ‘10’, ‘11’), the SR could be for indicating/initiating/triggering the P/SP/AP CSI-RS(s) measurement and/or reporting, i.e., the SR is a first SR as specified herein in the present disclosure. Optionally, a SR sent by the UE could be a bitmap with at least an entry/bit position of the bitmap associated/corresponding to the UE-initiated/triggered P/SP/AP CSI-RS measurement and/or reporting; the entry(s)/bit position(s) of the bitmap associated/corresponding to the UE-initiated/triggered P/SP/AP CSI-RS measurement and/or reporting could be determined according to: (i) fixed value(s) in system specification(s)—e.g., the first or the last, (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., via/in part of a CSI/beam report and/or UE's capability signaling(s); when/if the entry(s)/bit position(s) of the bitmap (and therefore, the SR) is set to ‘1’ (or ‘0’), the SR could be for indicating/initiating/triggering the P/SP/AP CSI-RS(s) measurement and/or reporting—i.e., the SR is a first SR as specified herein in the present disclosure.
   Yet for another example, the UE could send to the network, e.g., along with the transmission(s) of the SR(s) and/or in/via part of a beam/CSI report and/or in/via UE's capability signaling(s) and/or in/via corresponding PUCCH(s)/PUSCH(s)/physical random access channel(s) (PRACH(s))/etc., a set/list of one or more SR IDs and/or SR configuration IDs. For this case/design example, the SR(s) and/or the SR configuration(s) associated/corresponding to the SR ID(s) and/or SR configuration ID(s) in the set/list could be for indicating/initiating/triggering the P/SP/AP CSI-RS(s) measurement and/or reporting—i.e., the first SR(s)/first SR configuration(s)—as specified herein in the present disclosure.
   Yet for another example, the UE could send to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., a bitmap with each entry/bit position of the bitmap associated/corresponding to a SR ID or a SR configuration ID; for this case/design example, when/if an entry/bit position of the bitmap is set to ‘1’ (or ‘0’), the corresponding/associated SR ID or SR configuration ID (and therefore, the corresponding SR or SR configuration) could be for indicating/initiating/triggering the P/SP/AP CSI-RS(s) measurement and/or reporting—i.e., a first SR/first SR configuration—as specified herein in the present disclosure. Alternatively, the UE could send to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., one or more indicators each associated/corresponding to a SR ID or a SR configuration ID; for this case/design example, when/if an aforementioned indicator is set to ‘1’ (or ‘0’) or ‘enabled’ (or ‘disabled’) or ‘ueInitiatedBeamReporting’ or ‘00’ (or ‘01’, ‘10’, ‘11’), the corresponding/associated SR ID or SR configuration ID (and therefore, the corresponding SR or SR configuration) could be associated/corresponding to a first SR and used to indicate/trigger/initiate P/SP/AP CSI-RS(s) measurement and/or reporting—i.e., a first SR/first SR configuration—as specified herein in the present disclosure.
   Yet for another example, one or more PUCCH resources and/or one or more PUCCH resource groups (and therefore, the PUCCH resource(s) configured/provided therein) and/or one or more PUCCH resource sets (and therefore, the PUCCH resource(s) configured/provided therein) could be associated to/with or could be used to indicate/trigger/initiate P/SP/AP CSI-RS measurement and/or reporting as specified herein in the present disclosure-referred to as first PUCCH resource(s) and/or first PUCCH resource group(s) and/or first PUCCH resource set(s), e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s).
      In one example, the PUCCH resource(s) that is transmitted/received the first/last in time—e.g., among one or more transmitted/received PUCCH resources, and/or the K≥1 PUCCH resources that are transmitted/received the first/last in time—e.g., among one or more transmitted/received PUCCH resources, wherein the value of K could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the PUCCH resource with the lowest/highest PUCCH resource ID—e.g., among one or more PUCCH resources, and/or the L≥1 PUCCH resources with the highest/lowest PUCCH resource IDs—e.g., among one or more PUCCH resources, wherein the value of L could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the PUCCH resource(s) with odd PUCCH resource ID(s), and/or the PUCCH resource(s) with even PUCCH resource ID(s), and/or the PUCCH resource configured/provided/indicated in a PUCCH resource group/set with the lowest/highest PUCCH resource group/set ID—e.g., among one or more PUCCH resource groups (sets)/PUCCH resource group (set) IDs, and/or the M≥1 PUCCH resources configured/provided/indicated in PUCCH resource groups/sets with the lowest/highest PUCCH resource group/set IDs—e.g., among one or more PUCCH resource groups (sets)/PUCCH resource group (set) IDs, wherein the value of M could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the PUCCH resource(s) provided/configured/indicated in the PUCCH resource group(s)/set(s) with odd PUCCH resource group/set ID(s), and/or the PUCCH resource(s) provided/configured/indicated in the PUCCH resource group(s)/set(s) with even PUCCH resource group/set ID(s), could correspond to the one or more first PUCCH resources (or PUCCH resource IDs) associated/corresponding to or used to indicate/trigger/initiate P/SP/AP CSI-RS measurement and/or reporting as specified herein in the present disclosure.
      In another example, the PUCCH resource group/set (and therefore, the PUCCH resource(s) configured/provided/indicated therein) with the lowest/highest PUCCH resource group/set ID—e.g., among one or more PUCCH resource groups (sets)/PUCCH resource group (set) IDs, and/or the M≥1 PUCCH resource groups/sets (and therefore, the PUCCH resource(s) configured/provided/indicated therein) with the lowest/highest PUCCH resource group/set IDs—e.g., among one or more PUCCH resource groups (sets)/PUCCH resource group (set) IDs, wherein the value of M could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the PUCCH resource group(s)/set(s) with odd PUCCH resource group/set ID(s), and/or the PUCCH resource group(s)/set(s) with even PUCCH resource group/set ID(s), could correspond to the one or more first PUCCH resource groups/sets (or PUCCH resource group/set IDs) associated/corresponding to or used to indicate/trigger/initiate P/SP/AP CSI-RS measurement and/or reporting as specified herein in the present disclosure.
      In yet another example, an indicator/configuration could be provided/indicated/configured in the higher layer parameter, e.g., PUCCH-Config or PUCCH-Resource, that configures a PUCCH resource; for this case, when/if the indicator/configuration is set to ‘1’ (or ‘0’) or ‘00’ (or ‘01’, ‘10’, ‘11’) or ‘enabled’ (or ‘disabled’) or ‘ueInitiatedBeamReporting’, the corresponding/associated PUCCH resource could be for indicating/initiating/triggering the P/SP/AP CSI-RS(s) measurement and/or reporting—i.e., a first PUCCH resource—as specified herein in the present disclosure. The described/specified indication/configuration herein could also be provided/indicated/configured by the network, e.g., via MAC CE command(s) and/or dynamic DCI based L1 signaling(s) associated/corresponding to a PUCCH resource.
      In yet another example, an indicator/configuration could be provided/indicated/configured in the higher layer parameter, e.g., PUCCH-Config or PUCCH-ResourceSet or PUCCH-ResourceGroup or pucch-ResourceCommon, that configures a PUCCH resource group/set; for this case, when/if the indicator/configuration is set to ‘1’ (or ‘0’) or ‘00’ (or ‘01’, ‘10’, ‘11’) or ‘enabled’ (or ‘disabled’) or ‘ueInitiatedBeamReporting’, the corresponding/associated PUCCH resource group/set (and therefore, the PUCCH resource(s) provided/configured therein) could be for indicating/initiating/triggering the P/SP/AP CSI-RS(s) measurement and/or reporting—i.e., a first PUCCH resource group/set—as specified herein in the present disclosure. The described/specified indication/configuration herein could also be provided/indicated/configured by the network, e.g., via MAC CE command(s) and/or dynamic DCI based L1 signaling(s) associated/corresponding to a PUCCH resource group/set.
      In yet another example, a bitmap could be provided/indicated/configured in the higher layer parameter, e.g., PUCCH-Config or PUCCH-Resource, that configures a PUCCH resource; at least an entry/bit position of the bitmap could be associated/corresponding to the UE-initiated/triggered P/SP/AP CSI-RS measurement and/or reporting; the entry(s)/bit position(s) of the bitmap associated/corresponding to the UE-initiated/triggered P/SP/AP CSI-RS measurement and/or reporting could be determined according to: (i) fixed value(s) in system specification(s)—e.g., the first or the last, (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., via/in part of a CSI/beam report and/or UE's capability signaling(s). For this case, when/if the entry(s)/bit position(s) of the bitmap is set to ‘1’ (or ‘0’), the corresponding/associated PUCCH resource could be for indicating/initiating/triggering the P/SP/AP CSI-RS(s) measurement and/or reporting—i.e., a first PUCCH resource—as specified herein in the present disclosure.
      In yet another example, a bitmap could be provided/indicated/configured in the higher layer parameter, e.g., PUCCH-Config or PUCCH-Resource or PUCCH-ResourceSet or PUCCH-ResourceGroup or pucch-ResourceCommon, that configures a PUCCH resource group/set; at least an entry/bit position of the bitmap could be associated/corresponding to the UE-initiated/triggered P/SP/AP CSI-RS measurement and/or reporting; the entry(s)/bit position(s) of the bitmap associated/corresponding to the UE-initiated/triggered P/SP/AP CSI-RS measurement and/or reporting could be determined according to: (i) fixed value(s) in system specification(s)—e.g., the first or the last, (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., via/in part of a CSI/beam report and/or UE's capability signaling(s). For this case, when/if the entry(s)/bit position(s) of the bitmap is set to ‘1’ (or ‘0’), the corresponding/associated PUCCH resource group/set (and therefore, the corresponding PUCCH resource(s) provided/configured therein) could be for indicating/initiating/triggering the P/SP/AP CSI-RS(s) measurement and/or reporting—i.e., a first PUCCH resource group/set—as specified herein in the present disclosure.
      In yet another example, the UE could be provided/indicated/configured by the network, e.g., via higher layer RRC signaling(s)/parameter(s) and/or MAC CE command(s) and/or dynamic DCI based L1 signaling(s), a set/list of one or more PUCCH resource IDs and/or PUCCH resource set IDs and/or PUCCH resource group IDs. For this case/design example, the PUCCH resource(s) and/or the PUCCH resource set(s)—and therefore, the PUCCH resource(s) provided/configured therein—and/or the PUCCH resource group(s)—and therefore, the PUCCH resource(s) provided/configured therein—associated/corresponding to the provided/indicated/configured PUCCH resource ID(s) and/or PUCCH resource set ID(s) and/or PUCCH resource group ID(s) could be for indicating/initiating/triggering the P/SP/AP CSI-RS(s) measurement and/or reporting—i.e., the first PUCCH resource(s)/first PUCCH resource group(s)/first PUCCH resource set(s)—as specified herein in the present disclosure.
      In yet another example, the UE could be provided/indicated/configured by the network, e.g., via higher layer RRC signaling(s)/parameter(s) and/or MAC CE command(s) and/or dynamic DCI based L1 signaling(s), a bitmap with each entry/bit position of the bitmap associated/corresponding to a PUCCH resource ID or a PUCCH resource set ID or a PUCCH resource group ID; for this case/design example, when/if an entry/bit position of the bitmap is set to ‘1’ (or ‘0’), the corresponding/associated PUCCH resource ID (or PUCCH resource) or PUCCH resource set ID (or PUCCH resource set) or PUCCH resource group ID (or PUCCH resource group)—and therefore, the PUCCH resource(s) provided/configured therein—could be for indicating/initiating/triggering the P/SP/AP CSI-RS(s) measurement and/or reporting—i.e., the first PUCCH resource(s)/first PUCCH resource set(s)/first PUCCH resource group(s)—as specified herein in the present disclosure. Alternatively, the UE could be provided/indicated/configured by the network, e.g., via higher layer RRC signaling(s)/parameter(s) and/or MAC CE command(s) and/or dynamic DCI based L1 signaling(s), one or more indicators each associated/corresponding to a PUCCH resource ID or a PUCCH resource set ID or a PUCCH resource group ID; for this case/design example, when/if an aforementioned indicator is set to ‘1’ (or ‘0’) or ‘enabled’ (or ‘disabled’) or ‘ueInitiatedBeamReporting’ or ‘00’ (or ‘01’, ‘10’, ‘11’), the corresponding/associated PUCCH resource ID (or PUCCH resource) or PUCCH resource set ID (or PUCCH resource set) or PUCCH resource group ID (or PUCCH resource group)—and therefore, the PUCCH resource(s) provided/configured therein—could be for indicating/initiating/triggering the P/SP/AP CSI-RS(s) measurement and/or reporting—i.e., the first PUCCH resource(s)/first PUCCH resource set(s)/first PUCCH resource group(s)—as specified herein in the present disclosure.
      In yet another example, the UE could send to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., a set/list of one or more PUCCH resource IDs and/or PUCCH resource set IDs and/or PUCCH resource group IDs. For this case/design example, the PUCCH resource(s) and/or the PUCCH resource set(s)—and therefore, the PUCCH resource(s) provided/configured therein—and/or the PUCCH resource group(s)—and therefore, the PUCCH resource(s) provided/configured therein—associated/corresponding to the PUCCH resource ID(s) and/or PUCCH resource set ID(s) and/or PUCCH resource group ID(s) in the set/list could be for indicating/initiating/triggering the P/SP/AP CSI-RS(s) measurement and/or reporting—i.e., the first PUCCH resource(s)/first PUCCH resource group(s)/first PUCCH resource set(s)—as specified herein in the present disclosure.
      In yet another example, the UE could send to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., a bitmap with each entry/bit position of the bitmap associated/corresponding to a PUCCH resource ID or a PUCCH resource set ID or a PUCCH resource group ID; for this case/design example, when/if an entry/bit position of the bitmap is set to ‘1’ (or ‘0’), the corresponding/associated PUCCH resource ID (or PUCCH resource) or PUCCH resource set ID (or PUCCH resource set) or PUCCH resource group ID (or PUCCH resource group)—and therefore, the PUCCH resource(s) provided/configured therein—could be for indicating/initiating/triggering the P/SP/AP CSI-RS(s) measurement and/or reporting—i.e., the first PUCCH resource(s)/first PUCCH resource set(s)/first PUCCH resource group(s)—as specified herein in the present disclosure. Alternatively, the UE could send to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., one or more indicators each associated/corresponding to a PUCCH resource ID or a PUCCH resource set ID or a PUCCH resource group ID; for this case/design example, when/if an aforementioned indicator is set to ‘1’ (or ‘0’) or ‘enabled’ (or ‘disabled’) or ‘ueInitiatedBeamReporting’ or ‘00’ (or ‘01’, ‘10’, ‘11’), the corresponding/associated PUCCH resource ID (or PUCCH resource) or PUCCH resource set ID (or PUCCH resource set) or PUCCH resource group ID (or PUCCH resource group)—and therefore, the PUCCH resource(s) provided/configured therein—could be for indicating/initiating/triggering the P/SP/AP CSI-RS(s) measurement and/or reporting—i.e., the first PUCCH resource(s)/first PUCCH resource set(s)/first PUCCH resource group(s)—as specified herein in the present disclosure.

A SR or a SR configuration could be associated/corresponding to one or more first PUCCH resources and/or one or more first PUCCH resource sets/groups as specified herein in the present disclosure; for this case, the SR or the SR configuration could correspond to a first SR or a first SR configuration for indicating/initiating/triggering the P/SP/AP CSI-RS(s) measurement and/or reporting.
Yet for another example, up to S (e.g., S=8) scheduling request resources/scheduling request resource IDs could be configured/provided, e.g., in a SR configuration. One or more of the SR resources/SR resource IDs configured/provided in a SR configuration could be associated/corresponding to the one or more first SRs and used to indicate/trigger/initiate P/SP/AP CSI-RS measurement and/or reporting as specified herein in the present disclosure, e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s).
   In one example, the first/last SR resource—e.g., among the one or more SR resources provided/configured in a SR configuration, and/or the SR resource with the lowest/highest SR resource ID—e.g., among the one or more SR resources provided/configured in a SR configuration, and/or the first/last K≥1 SR resources—e.g., among the one or more SR resources provided/configured in a SR configuration, wherein the value of K could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the L≥1 SR resources with the highest/lowest SR resource IDs—e.g., among the one or more SR resources in a SR configuration, wherein the value of L could be determined according to: (1) fixed value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in/via part of a CSI/beam report and/or UE's capability signaling(s), and/or the SR resource(s) with odd SR resource ID(s)—e.g., among the one or more SR resources in a SR configuration, and/or the SR resource(s) with even SR resource ID(s)—e.g., among the one or more SR resources in a SR configuration, could be associated/corresponding to the one or more first SRs and used to indicate/trigger/initiate P/SP/AP CSI-RS measurement and/or reporting as specified herein in the present disclosure.
   In another example, the UE could be provided/configured/indicated by the network, e.g., via higher layer RRC signaling(s)/parameter(s) and/or MAC CE command(s) and/or dynamic DCI based L1 signaling(s), a list/set of SR resource IDs—e.g., among one or more SR resource IDs in a SR configuration as specified herein in the present disclosure. For this case/design example, the SR resource(s) associated/corresponding to the provided/configured/indicated SR resource ID(s) could be associated/corresponding to the one or more first SRs and used to indicate/trigger/initiate P/SP/AP CSI-RS(s) measurement and/or reporting as specified herein in the present disclosure.
   In yet another example, the UE could be provided/configured/indicated by the network, e.g., via higher layer RRC signaling(s)/parameter(s) and/or MAC CE command(s) and/or dynamic DCI based L1 signaling(s), a bitmap with each entry/bit position of the bitmap corresponding/associated to a SR resource/SR resource ID in a SR configuration; for this case/design example, when/if an entry/bit position of the bitmap is set to ‘1’ (or ‘0’), the corresponding/associated SR resource (or SR resource ID) in the SR configuration could be associated/corresponding to a first SR and used to indicate/trigger/initiate P/SP/AP CSI-RS(s) measurement and/or reporting as specified herein in the present disclosure. Alternatively, the UE could be provided/configured/indicated by the network, e.g., via higher layer RRC signaling(s)/parameter(s) and/or MAC CE command(s) and/or dynamic DCI based L1 signaling(s), one or more indicators each associated to a SR resource/SR resource ID in a SR configuration; for this case/design example, when/if an aforementioned indicator is set to ‘1’ (or ‘0’) or ‘enabled’ (or ‘disabled’) or ‘ueInitiatedBeamReporting’ or ‘00’ (or ‘01’, ‘10’, ‘11’), the corresponding/associated SR resource (or SR resource ID) in the SR configuration could be associated/corresponding to a first SR and used to indicate/trigger/initiate P/SP/AP CSI-RS(s) measurement and/or reporting as specified herein in the present disclosure.
   In yet another example, the UE could report to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., a list/set of SR resource IDs—e.g., among one or more SR resource IDs in a SR configuration as specified herein in the present disclosure. For this case/design example, the SR resource(s) associated/corresponding to the SR resource ID(s) in the list/set could be associated/corresponding to the one or more first SRs and used to indicate/trigger/initiate P/SP/AP CSI-RS(s) measurement and/or reporting as specified herein in the present disclosure.
   In yet another example, the UE could report to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., a bitmap with each entry/bit position of the bitmap corresponding/associated to a SR resource/SR resource ID in a SR configuration; for this case/design example, when/if an entry/bit position of the bitmap is set to ‘1’ (or ‘0’), the corresponding/associated SR resource (or SR resource ID) in the SR configuration could be associated/corresponding to a first SR and used to indicate/trigger/initiate P/SP/AP CSI-RS(s) measurement and/or reporting as specified herein in the present disclosure. Alternatively, the UE could report to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc., one or more indicators each associated to a SR resource/SR resource ID in a SR configuration; for this case/design example, when/if an aforementioned indicator is set to ‘1’ (or ‘0’) or ‘enabled’ (or ‘disabled’) or ‘ueInitiatedBeamReporting’ or ‘00’ (or ‘01’, ‘10’, ‘11’), the corresponding/associated SR resource (or SR resource ID) in the SR configuration could be associated/corresponding to a first SR and used to indicate/trigger/initiate P/SP/AP CSI-RS(s) measurement and/or reporting as specified herein in the present disclosure.
   In another example, the UE could receive from the network a MAC CE activation command activating/indicating one or more SR resource IDs from the one or more (up to S, e.g., S=8) SR resource IDs provided in the SR configuration as specified herein in the present disclosure. For this case/design example, the activated/indicated SR resource ID(s)—and therefore, the corresponding SR(s)/SR resource(s)—could be associated/corresponding to the one or more first SRs and used to indicate/trigger/initiate P/SP/AP CSI-RS(s) measurement and/or reporting as specified herein in the present disclosure.
In yet another example, one or more second SRs (or SR IDs) or one or more second SR configurations (or SR configuration IDs) could be associated to/with or could be used to indicate/trigger/initiate TCI state(s)/beam(s) activation/deactivation/sub-selection as specified herein in the present disclosure, e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s). The determination(s)/selection(s)/configuration(s)/indication(s) of the one or more second SRs (or SR IDs) and/or the one or more second SR configurations (or SR configuration IDs) for indicating/triggering/initiating the TCI state(s)/beam(s) activation/deactivation/sub-selection could follow those specified/defined in the present disclosure (e.g., those specified in one or more examples described herein) for the determination(s)/selection(s)/configuration(s)/indication(s) of the one or more first SRs (or SR IDs) and/or the one or more first SR configurations (or SR configuration IDs) for indicating/triggering/initiating P/SP/AP CSI-RS(s) measurement and/or reporting as specified herein in the present disclosure, e.g., by replacing the first SR(s)/SR ID(s) with the second SR(s)/SR ID(s), the first SR configuration(s)/SR configuration ID(s) with the second SR configuration(s)/SR configuration ID(s), ‘ueInitiatedBeamReporting’ with ‘ueInitiatedBeamActivation’, P/SP/AP CSI-RS(s) measurement and/or reporting with TCI state(s)/beam(s) activation/deactivation/sub-selection, first PUCCH resource(s)/PUCCH resource ID(s) with second PUCCH resource(s)/PUCCH resource ID(s), first PUCCH resource group(s)/PUCCH resource group ID(s) with second PUCCH resource group(s)/PUCCH resource group ID(s), and/or first PUCCH resource set(s)/PUCCH resource set ID(s) with second PUCCH resource set(s)/PUCCH resource set ID(s) . . . .
In yet another example, one or more third SRs (or SR IDs) or one or more third SR configurations (or SR configuration IDs) could be associated to/with or could be used to indicate/trigger/initiate TCI state(s)/beam(s) switching/change/update as specified herein in the present disclosure, e.g., according to: (i) fixed rule(s)/value(s) in system specification(s), (ii) network's configuration(s)/indication(s), via higher layer e.g., RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s). The determination(s)/selection(s)/configuration(s)/indication(s) of the one or more third SRs (or SR IDs) and/or the one or more third SR configurations (or SR configuration IDs) for indicating/triggering/initiating the TCI state(s)/beam(s) switching/change/update could follow those specified/defined in the present disclosure (e.g., those specified in one or more examples described herein) for the determination(s)/selection(s)/configuration(s)/indication(s) of the one or more first SRs (or SR IDs) and/or the one or more first SR configurations (or SR configuration IDs) for indicating/triggering/initiating P/SP/AP CSI-RS(s) measurement and/or reporting as specified herein in the present disclosure, e.g., by replacing the first SR(s)/SR ID(s) with the third SR(s)/SR ID(s), the first SR configuration(s)/SR configuration ID(s) with the third SR configuration(s)/SR configuration ID(s), ‘ueInitiatedBeamReporting’ with ‘ueInitiatedBeamSwitching’, P/SP/AP CSI-RS(s) measurement and/or reporting with TCI state(s)/beam(s) switching/change/update, first PUCCH resource(s)/PUCCH resource ID(s) with third PUCCH resource(s)/PUCCH resource ID(s), first PUCCH resource group(s)/PUCCH resource group ID(s) with third PUCCH resource group(s)/PUCCH resource group ID(s), and/or first PUCCH resource set(s)/PUCCH resource set ID(s) with third PUCCH resource set(s)/PUCCH resource set ID(s).
In yet another example, the SR(s) as specified herein in the present disclosure could be of x-bit (e.g., x=1 or 2); the value(s) of x could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s).
   For example, the SR could be a one-bit indicator. In one example, when/if the SR is set to ‘0’ (or ‘1’), the SR could correspond to a first SR as specified herein in the present disclosure to indicate/trigger/initiate P/SP/AP CSI-RS(s) measurement and/or reporting, and/or when/if the SR is set to ‘1’ (or ‘0’), the SR could correspond to a second SR as specified herein in the present disclosure to indicate/trigger/initiate TCI state(s)/beam(s) activation/deactivation/sub-selection. In another example, when/if the SR is set to ‘0’ (or ‘1’), the SR could correspond to a first SR as specified herein in the present disclosure to trigger/indicate/initiate P/SP/AP CSI-RS(s) measurement and/or reporting, and/or when/if the SR is set to ‘1’ (or ‘0’), the SR could correspond to a third SR as specified herein in the present disclosure to trigger/indicate/initiate TCI state(s)/beam(s) switching/change/update. In yet another example, when/if the SR is set to ‘0’ (or ‘1’), the SR could correspond to a second SR as specified herein in the present disclosure to trigger/indicate/initiate TCI state(s)/beam(s) activation/deactivation/sub-selection, and/or when/if the SR is set to ‘1’ (or ‘0’), the SR could correspond to a third SR as specified herein in the present disclosure to trigger/indicate/initiate TCI state(s)/beam(s) switching/change/update.
   For another example, the SR could be a multi-bit indicator (e.g., x=2). E.g., when/if the SR is set to ‘00’ (or ‘01’ or ‘10’ or ‘11’), the SR could correspond to a first SR as specified herein in the present disclosure to trigger/indicate/initiate P/SP/AP CSI-RS(s) measurement and/or reporting, and/or when/if the SR is set to ‘01’ (or ‘00’ or ‘10’ or ‘11’), the SR could correspond to a second SR as specified herein in the present disclosure to initiate/trigger/indicate TCI state(s)/beam(s) activation/deactivation/sub-selection, and/or when/if the SR is set to ‘10’ (or ‘00’ or ‘01’ or ‘11’), the SR could correspond to a third SR as specified herein in the present disclosure to trigger/indicate/initiate TCI state(s)/beam(s) switching/change/update.
In yet another example, the SR(s) as specified herein in the present disclosure could be of multi-level (e.g., y-level with y=1, 2, 3, 4) depending on/according to, e.g., payload size(s) of the SR(s); the value(s) of y could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s).
   For example, the SR could be of two-level. In one example, when/if the payload size of the SR is greater than or equal to y0 but less than or equal to y1 (i.e., the first level), the SR could correspond to a first SR as specified herein in the present disclosure to trigger/indicate/initiate P/SP/AP CSI-RS(s) measurement and/or reporting, and/or when/if the payload size of the SR is greater than or equal to y2 but less than or equal to y3 (i.e., the second level), the SR could correspond to a second SR as specified herein in the present disclosure to trigger/initiate/indicate TCI state(s)/beam(s) activation/deactivation/sub-selection. In another example, when/if the payload size of the SR is greater than or equal to y0 but less than or equal to y1 (i.e., the first level), the SR could correspond to a first SR as specified herein in the present disclosure to trigger/indicate/initiate P/SP/AP CSI-RS(s) measurement and/or reporting, and/or when/if the payload size of the SR is greater than or equal to y2 but less than or equal to y3 (i.e., the second level), the SR could correspond to a third SR as specified herein in the present disclosure to initiate/trigger/indicate TCI state(s)/beam(s) switching/change/update. In yet another example, when/if the payload size of the SR is greater than or equal to y0 but less than or equal to y1 (i.e., the first level), the SR could correspond to a second SR as specified herein in the present disclosure to trigger/indicate/initiate TCI state(s)/beam(s) activation/deactivation/sub-selection, and/or when/if the payload size of the SR is greater than or equal to y2 but less than or equal to y3 (i.e., the second level), the SR could correspond to a third SR as specified herein in the present disclosure to trigger/indicate/initiate TCI state(s)/beam(s) switching/change/update. The value(s) of y0, y1, y2 and/or y3 could be determined according to (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s). Furthermore, y2 could be greater than or equal to y1.
   For another example, the SR could be of three-level. E.g., when/if the payload size of the SR is greater than or equal to y0 but less than or equal to y1 (i.e., the first level), the SR could correspond to a first SR as specified herein in the present disclosure to trigger/initiate/indicate P/SP/AP CSI-RS(s) measurement and/or reporting (or a second SR as specified herein in the present disclosure to trigger/indicate/initiate TCI state(s)/beam(s) activation/deactivation/sub-selection or a third SR as specified herein in the present disclosure to trigger/indicate/initiate TCI state(s)/beam(s) switching/change/update), and/or when/if the payload size of the SR is greater than or equal to y2 but less than or equal to y3 (i.e., the second level), the SR could correspond to a second SR as specified herein in the present disclosure to trigger/indicate/initiate TCI state(s)/beam(s) activation/deactivation/sub-selection (or a first SR as specified herein in the present disclosure to trigger/initiate/indicate P/SP/AP CSI-RS(s) measurement and/or reporting or a third SR as specified herein in the present disclosure to trigger/indicate/initiate TCI state(s)/beam(s) switching/change/update), and/or when/if the payload size of the SR is greater than or equal to y4 but less than or equal to y5 (i.e., the third level), the SR could correspond to a third SR as specified herein in the present disclosure to trigger/indicate/initiate TCI state(s)/beam(s) switching/change/update (or a first SR as specified herein in the present disclosure to trigger/initiate/indicate P/SP/AP CSI-RS(s) measurement and/or reporting or a second SR as specified herein in the present disclosure to trigger/indicate/initiate TCI state(s)/beam(s) activation/deactivation/sub-selection). The value(s) of y0, y1, y2, y3, y4 and/or y5 could be determined according to (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s). Furthermore, y2 could be greater than or equal to y1, and/or y4 could be greater than or equal to y3.
In yet another example, the SR(s) as specified herein in the present disclosure could be of or associated/corresponding to one or multiple (e.g., z=1, 2, 3) SR configurations. The value(s) of z could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s).
   For example, the UE (e.g. the UE 116) could report to the network (e.g. the network 130) a capability of supporting two or more SR configurations (e.g., for the UE-initiated/triggered reporting and/or beam management as specified herein in the present disclosure), and could be configured/provided by the network a corresponding first SR configuration and a corresponding second SR configuration. In one example, when/if the SR corresponds to or is of or is via the first SR configuration as specified herein in the present disclosure, the SR could correspond to a first SR as specified herein in the present disclosure to trigger/indicate/initiate P/SP/AP CSI-RS(s) measurement and/or reporting, and/or when/if the SR corresponds to or is of or is via the second SR configuration as specified herein in the present disclosure, the SR could correspond to a second SR as specified herein in the present disclosure to initiate/trigger/indicate TCI state(s)/beam(s) activation/deactivation/sub-selection. In another example, when/if the SR corresponds to or is of or is via the first SR configuration as specified herein in the present disclosure, the SR could correspond to a first SR as specified herein in the present disclosure to trigger/indicate/initiate P/SP/AP CSI-RS(s) measurement and/or reporting, and/or when/if the SR corresponds to or is of or is via the second SR configuration as specified herein in the present disclosure, the SR could correspond to a third SR as specified herein in the present disclosure to trigger/initiate/indicate TCI state(s)/beam(s) switching/change/update. In yet another example, when/if the SR corresponds to or is of or is via the first SR configuration as specified herein in the present disclosure, the SR could correspond to a second SR as specified herein in the present disclosure to initiate/trigger/indicate TCI state(s)/beam(s) activation/deactivation/sub-selection, and/or when/if the SR corresponds to or is of or is via the second SR configuration as specified herein in the present disclosure, the SR could correspond to a third SR as specified herein in the present disclosure to trigger/initiate/indicate TCI state(s)/beam(s) switching/change/update.
   For another example, the UE could report to the network a capability of supporting three or more SR configurations (e.g., for the UE-initiated/triggered reporting and/or beam management as specified herein in the present disclosure), and could be configured/provided by the network a corresponding first SR configuration, a corresponding second SR configuration and a corresponding third SR configuration. E.g., when/if the SR corresponds to or is of or is via the first SR configuration as specified herein in the present disclosure, the SR could correspond to a first SR as specified herein in the present disclosure to trigger/indicate/initiate P/SP/AP CSI-RS(s) measurement and/or reporting (or a second SR as specified herein in the present disclosure to trigger/indicate/initiate TCI state(s)/beam(s) activation/deactivation/sub-selection or a third SR as specified herein in the present disclosure to initiate/trigger/indicate TCI state(s)/beam(s) switching/change/update), and/or when/if the SR corresponds to or is of or is via the second SR configuration as specified herein in the present disclosure, the SR could correspond to a second SR as specified herein in the present disclosure to initiate/trigger/indicate TCI state(s)/beam(s) activation/deactivation/sub-selection (or a first SR as specified herein in the present disclosure to trigger/indicate/initiate P/SP/AP CSI-RS measurement and/or reporting or a third SR as specified herein in the present disclosure to trigger/indicate/initiate TCI state(s)/beam(s) switching/change/update), and/or when/if the SR corresponds to or is of or is via the third SR configuration as specified herein in the present disclosure, the SR could correspond to a third SR as specified herein in the present disclosure to trigger/initiate/indicate TCI state(s)/beam(s) switching/change/update (or a first SR as specified herein in the present disclosure to trigger/indicate/initiate P/SP/AP CSI-RS(s) measurement and/or reporting or a second SR as specified herein in the present disclosure to initiate/trigger/indicate TCI state(s)/beam(s) activation/deactivation/sub-selection).

Throughout the present disclosure, a PUCCH resource could also be referred to as a PUCCH resource provided by PUCCH-Resource, a PUCCH resource configuration provided by PUCCH-Config, a PUCCH resource set provided by PUCCH-ResourceSet or pucch-CommonResource, and/or a PUCCH resource group provided by PUCCH-ResourceGroup or pucch-CommonResource; that is, they—the configurations/terminologies—can be used interchangeably or can be replaced by/with each other or can be equivalent to each other. The association(s)/mapping(s) between the SR(s)/SR ID(s)/SR configuration(s)/SR configuration ID(s) and (1) P/SP/AP CSI-RS(s) measurement and/or reporting and/or (2) TCI state(s)/beam(s) activation/deactivation/sub-selection and/or (3) TCI state(s)/beam(s) switching/change/update according to those specified herein in the present disclosure could be (re-)configured by/via RRC and/or updated by MAC CE and/or updated/indicated via DCI based L1 signaling(s). That is, the usage(s)/use(s) of the SR (s/SR configuration(s) to trigger/initiate/indicate (1) P/SP/AP CSI-RS(s) measurement and/or reporting—e.g., as the first SR/SR configuration as specified herein in the present disclosure and/or (2) TCI state(s)/beam(s) activation/deactivation/sub-selection—e.g., as the second SR/SR configuration as specified herein in the present disclosure and/or (3) TCI state(s)/beam(s) switching/change/update—e.g., as the third SR/SR configuration as specified herein in the present disclosure could be (re-)configured by/via RRC and/or updated by MAC CE and/or updated/indicated via DCI based L1 signaling(s).

A UE could send to the network, e.g., within a time window, one or more first SRs to trigger/initiate/indicate P/SP/AP CSI-RS(s) measurement and/or reporting as specified herein in the present disclosure, and/or one or more second SRs to trigger/initiate/indicate TCI state(s)/beam(s) activation/deactivation/sub-selection as specified herein in the present disclosure, and/or one or more third SRs to trigger/initiate/indicate TCI state(s)/beam(s) switching/change/update as specified herein in the present disclosure. Alternatively, a UE could send to the network, e.g., within a time window, a multi-bit/multi-level SR as specified herein in the present disclosure to trigger/initiate/indicate P/SP/AP CSI-RS(s) measurement and/or reporting and/or TCI state(s)/beam(s) activation/deactivation/sub-selection and/or TCI state(s)/beam(s) switching/change/update. Whether to send multiple SRs or a single SR to trigger/initiate/indicate P/SP/AP CSI-RS(s) measurement and/or reporting and/or TCI state(s)/beam(s) activation/deactivation/sub-selection and/or TCI state(s)/beam(s) switching/change/update could be: (1) determined according to/based on fixed rule(s) in system specification(s), (2) configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further sent to the network, e.g., in/via part of a/the CSI/beam report and/or UE's capability signaling(s). Furthermore, the (value of) time window could be (1) determined according to/based on fixed rule(s)/value(s) in system specification(s)—e.g., one or more slots/one or more symbols, (2) configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further sent to the network, e.g., in/via part of a/the CSI/beam report and/or UE's capability signaling(s).

Throughout the present disclosure, a CSI resource configuration could be referred to as or could correspond to one or more of the followings.
One or more CSI resource settings each provided by a higher layer parameter CSI-ResourceConfig
One or more CSI resource sets (e.g., one or more SSB resource sets and/or one or more nonzero power (NZP) CSI-RS resource sets) each provided by a higher layer parameter CSI-SSB-ResourceSet or nzp-CSI-RS-ResourceSet.
One or more CSI-RS resources (e.g., one or more SSB resources and/or one or more NZP CSI-RS resources) each provided by a higher layer parameter SSB-Index or NZP-CSI-RS-Resource
One or more CSI resource groups—e.g., configured/provided in a CSI resource set for non-coherent joint transmission (NCJT) CSI measurement and/or reporting (e.g., one or more SSB resource groups and/or one or more NZP CSI-RS resource groups)
One or more pairs of CSI-RS resources—e.g., each CSI-RS resource in a pair is from a different CSI resource group as specified herein in the present disclosure for NCJT CSI measurement and/or reporting (e.g., one or more pairs of SSB and/or NZP CSI-RS resources)

Furthermore, throughout the present disclosure, for a CSI resource configuration as specified/defined/described herein in the present disclosure, a CSI resource configuration ID could be referred to as or could correspond to one or more of the followings.
One or more CSI resource setting IDs each provided by a higher layer parameter CSI-ResourceConfigId.
One or more CSI resource set IDs (e.g., one or more SSB resource set IDs and/or one or more NZP CSI-RS resource set IDs) each provided by a higher layer parameter CSI-SSB-ResourceSetId or nzp-CSI-RS-ResourceSetId.
One or more CSI-RS resource IDs (e.g., one or more SSB resource IDs and/or one or more NZP CSI-RS resource IDs) each provided by a higher layer parameter SSB-Index or NZP-CSI-RS-ResourceId
One or more CSI resource group IDs—e.g., configured/provided in a CSI resource set for NCJT CSI measurement and/or reporting (e.g., one or more SSB resource group IDs and/or one or more NZP CSI-RS resource group IDs).
One or more CSI-RS resource pair IDs—e.g., each CSI-RS resource in a pair is from a different CSI resource group as specified herein in the present disclosure for NCJT CSI measurement and/or reporting (e.g., one or more SSB and/or NZP CSI-RS resource pair IDs)

In addition, throughout the present disclosure, a CSI reporting configuration could be referred to as or could correspond to one or more of the followings.
One or more CSI reporting settings each provided by CSI-ReportConfig and/or CSI-AssociatedReportConfigInfo.
One or more CSI reports in a CSI reporting setting provided by CSI-ReportConfig and/or CSI-AssociatedReportConfigInfo, wherein a CSI report could be associated/configured with one or more parameters/quantities such as reportQuantity, reportConfigType, reportFreqConfiguration and/or etc. provided in/by the CSI reporting setting
One or more aperiodic CSI trigger states each provided by CSI-AperiodicTriggerState and associated to one or more CSI reporting settings each provided by CSI-ReportConfig and/or CSI-AssociatedReportConfigInfo

Furthermore, throughout the present disclosure, for a CSI reporting configuration as specified/defined/described herein in the present disclosure, a CSI reporting configuration ID could be referred to as or could correspond to one or more of the followings.
One or more CSI reporting setting IDs each provided by reportConfigId
One or more CSI-Report IDs/indexes in a CSI reporting setting provided by CSI-ReportConfig, wherein a CSI-Report could be associated/configured with one or more parameters/quantities such as reportQuantity, reportConfigType, reportFreqConfiguration and/or etc. provided in/by the CSI reporting setting
One or more aperiodic CSI trigger states/trigger state IDs/trigger state values each provided by a value between 1 to maxNrOfCSI-AperiodicTriggers, wherein as specified herein in the present disclosure, an aperiodic CSI trigger state could be provided by CSI-AperiodicTriggerState and associated to one or more CSI reporting settings each provided by CSI-ReportConfig and/or CSI-AssociatedReportConfigInfo

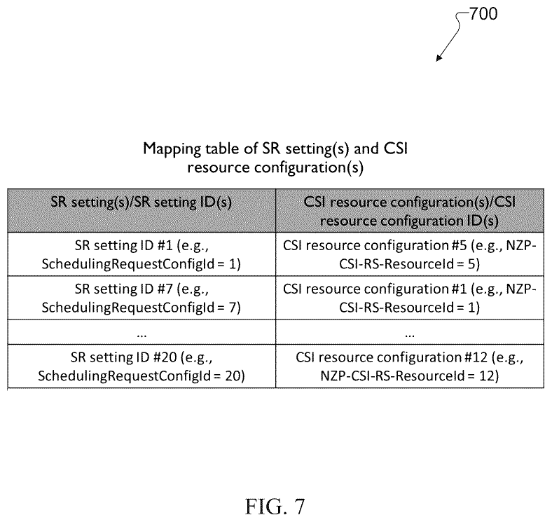

FIG. 7 illustrates a table of an example mapping 700 between SR settings and CSI resource configurations according to embodiments of the present disclosure. For example, mapping 700 between SR settings and CSI resource configurations can be referenced by any of the UEs 111-116 of FIG. 1, such as the UE 112. This example is for illustration only and other embodiments can be used without departing from the scope of the present disclosure.

Additionally, throughout the present disclosure, a SR setting could be referred to as or could correspond to one or more of the followings.
One or more SRs, e.g., for indicating/triggering/initiating periodic (P)/semi-persistent (SP) aperiodic (AP) CSI-RS(s) measurement/reporting and/or TCI state(s)/beam(s) activation/deactivation/sub-selection and/or TCI state(s)/beam(s) switching/change/update as specified herein in the present disclosure
One or more SR configurations each provided by SchedulingRequestConfig
One or more SR resources in a SR configuration provided by SchedulingRequestConfig

Furthermore, throughout the present disclosure, for a SR setting as specified/defined/described herein in the present disclosure, a SR setting ID could be referred to as or could correspond to one or more of the followings.
One or more SR IDs as specified herein in the present disclosure, wherein a SR with a SR ID could be for, e.g., indicating/triggering/initiating P/SP/AP CSI-RS(s) measurement/reporting and/or TCI state(s)/beam(s) activation/deactivation/sub-selection and/or TCI state(s)/beam(s) switching/change/update as specified herein in the present disclosure
One or more SR configuration IDs each provided by SchedulingRequestConfigId, wherein a SR configuration with a SR configuration ID could be provided by SchedulingRequestConfig.
One or more SR resource IDs each provided by schedulingRequestId, wherein a SR resource with a SR resource ID could be provided/configured in a SR configuration provided by SchedulingRequestConfig

Throughout the present disclosure, a PUCCH resource setting could be referred to as or could correspond to one or more of the followings.
One or more PUCCH resources each provided by PUCCH-Resource
One or more PUCCH resource sets each provided by PUCCH-ResourceSet or pucch-ResourceCommon.
One or more PUCCH resource groups each provided by PUCCH-ResourceGroup or pucch-ResourceCommon.
One or more PUCCH resource configurations each provided by PUCCH-Config
   Furthermore, throughout the present disclosure, for a PUCCH resource setting as specified/defined/described herein in the present disclosure, a PUCCH resource setting ID could be referred to as or could correspond to one or more of the followings.
One or more PUCCH resource IDs each provided by PUCCH-ResourceId.
One or more PUCCH resource set IDs each provided by PUCCH-ResourceSetId.
One or more PUCCH resource groups each provided by PUCCH-ResourceGroupId
One or more PUCCH resource configurations each provided by PUCCH-ConfigId
   According to or following those specified herein in the present disclosure, one or more PUCCH resource(s)—of a first UL channel—associated or specific to or provided by one or more PUCCH resource settings could be used to send, transmit, convey or carry a scheduling request or a UCI to:
(Mode A): request UL resource(s)—e.g., DG based PUSCH resource(s)—of a second UL channel to transmit a beam report which could comprise at least one resource indicator such as SSBRI or CRI and/or a corresponding beam metric such as L1-RSRP or L1-SINR; and/or
(Mode B): to notify a transmission of a beam report-comprising at least one resource indicator such as SSBRI or CRI and/or a corresponding beam metric such as L1-RSRP or L1-SINR-on one or more (pre-)configured UL resources of a second UL channel—e.g., Type1 CG PUSCH resource(s)—associated to the SR and/or the PUCCH resource of the first UL channel.

In one embodiment, a SR setting as specified herein in the present disclosure could be associated to/with one or more CSI resource configurations as specified herein in the present disclosure, e.g., according to: (i) fixed rule(s)/value(s) in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous selection/determination, which could be further sent to the network, e.g., via/in part of a CSI/beam report and/or UE's capability signaling(s).
In one example, the first (or last) SR setting—e.g., among one or more SR settings as specified herein in the present disclosure—could be associated to/with the first CSI resource configuration and/or the CSI resource configuration with the lowest CSI resource configuration ID—e.g., among one or more CSI resource configurations/CSI resource configuration IDs as specified herein in the present disclosure, the second (or second last) SR setting—e.g., among the one or more SR settings as specified herein in the present disclosure—could be associated to/with the second CSI resource configuration and/or the CSI resource configuration with the second lowest CSI resource configuration ID—e.g., among the one or more CSI resource configurations/CSI resource configuration IDs as specified herein in the present disclosure, and so on, and the last (or first) SR setting—e.g., among the one or more SR settings as specified herein in the present disclosure—could be associated to/with the last CSI resource configuration and/or the CSI resource configuration with the highest CSI resource configuration ID—e.g., among the one or more CSI resource configurations/CSI resource configuration IDs as specified herein in the present disclosure.
In another example, the SR setting with the lowest (or highest) SR setting ID—e.g., among one or more SR settings/SR setting IDs as specified herein in the present disclosure—could be associated to/with the first CSI resource configuration and/or the CSI resource configuration with the lowest CSI resource configuration ID—e.g., among one or more CSI resource configurations/CSI resource configuration IDs as specified herein in the present disclosure, the SR setting with the second lowest (or second highest) SR setting ID—e.g., among the one or more SR settings/SR setting IDs as specified herein in the present disclosure—could be associated to/with the second CSI resource configuration and/or the CSI resource configuration with the second lowest CSI resource configuration ID—e.g., among the one or more CSI resource configurations/CSI resource configuration IDs as specified herein in the present disclosure, and so on, and the SR setting with the highest (or lowest) SR setting ID—e.g., among the one or more SR settings/SR setting IDs as specified herein in the present disclosure—could be associated to/with the last CSI resource configuration and/or the CSI resource configuration with the highest CSI resource configuration ID—e.g., among the one or more CSI resource configurations/CSI resource configuration IDs as specified herein in the present disclosure.
In yet another example, the UE could be indicated/configured/provided by the network, e.g., via higher layer RRC signaling(s)/parameter(s) and/or MAC CE command(s) and/or dynamic DCI based L1 signaling(s), mapping/association relation(s) between one or more SR settings (and therefore, the corresponding SR setting ID(s)) and one or more CSI resource configurations (and therefore, the corresponding CSI resource configuration ID(s)). For example, the UE could be indicated/configured/provided by the network, e.g., via higher layer RRC signaling(s)/parameter(s) and/or MAC CE command(s) and/or dynamic DCI based L1 signaling(s), a (look-up) table, wherein the SR setting ID(s)—and therefore, the corresponding SR setting(s)—and the CSI resource configuration ID(s)—and therefore, the corresponding CSI resource configuration(s)—in the same row of the table could be associated/linked to each other (see FIG. 7); furthermore, one or more entries/rows of the table could be updated by/via RRC (re-)configuration and/or MAC CE and/or DCI, e.g., in form of bitmap(s). For another example, the UE could be indicated/configured/provided by the network, e.g., via higher layer RRC signaling(s)/parameter(s) and/or MAC CE command(s) and/or dynamic DCI based L1 signaling(s), a set/list of SR setting ID(s) and a set/list of CSI resource configuration ID(s) as specified herein in the present disclosure; for this case, the SR setting ID(s)—and therefore, the corresponding SR setting(s) as specified herein in the present disclosure—and the CSI resource configuration ID(s)—and therefore, the corresponding CSI resource configuration(s) as specified herein in the present disclosure—could be one-to-one mapped/associated following those described/specified in the present disclosure (e.g., those provided/specified in one or more examples described herein); furthermore, the set/list of SR setting ID(s) and/or the set/list of CSI resource configuration ID(s) could be updated by/via RRC (re-)configuration and/or MAC CE and/or DCI, e.g., in form of bitmap(s). Yet for another example, the UE could be indicated/configured/provided by the network, e.g., via higher layer RRC signaling(s)/parameter(s) and/or MAC CE command(s) and/or dynamic DCI based L1 signaling(s), a first bitmap with each entry/bit position of the first bitmap corresponding/associated to a SR setting ID/SR setting as specified herein in the present disclosure, and/or a second bitmap with each entry/bit position of the second bitmap corresponding/associated to a CSI resource configuration ID/CSI resource configuration as specified herein in the present disclosure—the first bitmap and the second bitmap could be identical or different; for this case, the SR setting ID(s)/SR setting(s) with their corresponding/associated entry(s)/bit position(s) in the first bitmap set to ‘1’ (or ‘0’) and the CSI resource configuration ID(s)/CSI resource configuration(s) with their corresponding/associated entry(s)/bit position(s) in the second bitmap set to ‘1’ (or ‘0’) could be one-to-one mapped/associated following those described/specified in the present disclosure (e.g., those provided/specified in one or more examples described herein); furthermore, the first and/or the second bitmap(s) could be updated by/via RRC (re-)configuration and/or MAC CE and/or DCI, e.g., in form of bitmap(s).
In yet another example, the UE could receive from the network, e.g., a RRC signaling/parameter and/or a MAC CE command and/or a DCI signaling/format, that provides/indicates/configures one or more SR settings/SR setting IDs. When/if the RRC signaling/parameter and/or the MAC CE command and/or the DCI signaling/format as specified herein in the present disclosure also provides/indicates/configures one or more CSI resource configurations/CSI resource configuration IDs, the one or more SR settings/SR setting IDs and the one or more CSI resource configurations/CSI resource configuration IDs provided/indicated/configured in the same RRC signaling/parameter and/or MAC CE command and/or DCI signaling/format could be one-to-one mapped/associated following those described/specified in the present disclosure (e.g., those provided/specified in one or more examples described herein).
In yet another example, the UE could receive from the network, e.g., a RRC signaling/parameter and/or a MAC CE command and/or a DCI signaling/format, that provides/indicates/configures one or more CSI resource configurations/CSI resource configuration IDs. When/if the RRC signaling/parameter and/or the MAC CE command and/or the DCI signaling/format as specified herein in the present disclosure also provides/indicates/configures one or more SR settings/SR setting IDs, the one or more CSI resource configurations/CSI resource configuration IDs and the one or more SR settings/SR setting IDs provided/indicated/configured in the same RRC signaling/parameter and/or MAC CE command and/or DCI signaling/format could be one-to-one mapped/associated following those described/specified in the present disclosure (e.g., those provided/specified in one or more examples described herein).
In yet another example, a RRC signaling/parameter and/or a MAC CE command and/or a DCI signaling/format that configures/provides/indicates a SR setting/SR setting ID as specified herein in the present disclosure (e.g., the higher layer RRC signaling/parameter SchedulingRequestConfig that configures/provides/indicates a SR configuration) could also configure/provide/indicate one or more CSI resource configurations/CSI resource configuration IDs as specified herein in the present disclosure (e.g., the higher layer parameter(s) nzp-CSI-RS-ResourceSetId and/or nzp-CSI-RS-ResourceId). For this case, the SR setting/SR setting ID (e.g., a SR configuration provided by SchedulingRequestConfig) could be mapped/associated to the one or more CSI resource configurations/CSI resource configuration IDs (e.g., one or more NZP CSI-RS resource sets each provided by nzp-CSI-RS-ResourceSet) provided/indicated/configured in the same RRC signaling/parameter and/or MAC CE command and/or DCI signaling/format as specified herein in the present disclosure.
In yet another example, a RRC signaling/parameter and/or a MAC CE command and/or a DCI signaling/format that configures/provides/indicates a CSI resource configuration/CSI resource configuration ID as specified herein in the present disclosure (e.g., the higher layer RRC signaling/parameter NZP-CSI-RS-Resource that configures/provides/indicates a NZP CSI-RS resource) could also configure/provide/indicate one or more SR settings/SR setting IDs as specified herein in the present disclosure (e.g., the higher layer parameter(s) SchedulingRequestId). For this case, the CSI resource configuration/CSI resource configuration ID (e.g., a NZP CSI-RS resource provided by NZP-CSI-RS-Resource) could be mapped/associated to the one or more SR settings/SR setting IDs (e.g., one or more SR resources each provided by SchedulingRequestId) provided/indicated/configured in the same RRC signaling/parameter and/or MAC CE command and/or DCI signaling/format as specified herein in the present disclosure.
In yet another example, a first RRC signaling/parameter and/or a first MAC CE command and/or a first DCI signaling/format that configures/provides/indicates a SR setting/SR setting ID as specified herein in the present disclosure (e.g., a SR resource provided by SchedulingRequestId) could also configure/provide/indicate a first indicator. In addition, a second RRC signaling/parameter and/or a second MAC CE command and/or a second DCI signaling/format that configures/provides/indicates a CSI resource configuration/CSI resource configuration ID as specified herein in the present disclosure (e.g., a NZP CSI-RS resource provided by NZP-CSI-RS-Resource) could also configure/provide/indicate a second indicator. When/if the first indicator and the second indicator are set to the same value(s) such as ‘1’ (or ‘0’), ‘enabled’ (or ‘disabled’), ‘00’ (or ‘01’, ‘10’, ‘11’), ‘on’ (or ‘off’), and/or etc., the SR setting/SR setting ID (e.g., the SR resource provided by SchedulingRequestId) provided/indicated/configured in/by the first RRC signaling/parameter and/or the first MAC CE command and/or the first DCI signaling/format could be associated/mapped to the CSI resource configuration/CSI resource configuration ID (e.g., the NZP CSI-RS resource provided by NZP-CSI-RS-Resource) provided/indicated/configured in/by the second RRC signaling/parameter and/or the second MAC CE command and/or the second DCI signaling/format.

The association(s)/mapping(s) between one or more SR settings/SR setting IDs and one or more CSI resource configurations/CSI resource configuration IDs determined/configured/indicated/provided according to those specified/defined/described in the present disclosure, e.g., those provided/specified in one or more examples described herein, could also be autonomously determined/selected/decided by the UE, which could be further reported by the UE to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc. In addition, the association(s)/mapping(s) between one or more SR settings/SR setting IDs and one or more CSI resource configurations/CSI resource configuration IDs determined/configured/indicated/provided according to those specified/defined/described in the present disclosure, e.g., those provided/specified in one or more examples described herein, could be applied/extended to associating/mapping between one or more SR settings/SR setting IDs and one or more parameters/quantities provided/configured in the one or more CSI resource configurations, e.g., by replacing the CSI resource configuration(s)/CSI resource configuration ID(s) according to one or more examples described herein by/with the one or more parameters/quantities provided/configured in the one or more CSI resource configurations.

In one embodiment, a SR setting as specified herein in the present disclosure could be associated to/with one or more CSI reporting configurations as specified herein in the present disclosure, e.g., according to: (i) fixed rule(s)/value(s) in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous selection/determination, which could be further sent to the network, e.g., via/in part of a CSI/beam report and/or UE's capability signaling(s).
In one example, the first (or last) SR setting—e.g., among one or more SR settings as specified herein in the present disclosure—could be associated to/with the first CSI reporting configuration and/or the CSI reporting configuration with the lowest CSI reporting configuration ID—e.g., among one or more CSI reporting configurations/CSI reporting configuration IDs as specified herein in the present disclosure, the second (or second last) SR setting—e.g., among the one or more SR settings as specified herein in the present disclosure—could be associated to/with the second CSI reporting configuration and/or the CSI reporting configuration with the second lowest CSI reporting configuration ID—e.g., among the one or more CSI reporting configurations/CSI reporting configuration IDs as specified herein in the present disclosure, and so on, and the last (or first) SR setting—e.g., among the one or more SR settings as specified herein in the present disclosure—could be associated to/with the last CSI reporting configuration and/or the CSI reporting configuration with the highest CSI reporting configuration ID—e.g., among the one or more CSI reporting configurations/CSI reporting configuration IDs as specified herein in the present disclosure.
In another example, the SR setting with the lowest (or highest) SR setting ID—e.g., among one or more SR settings/SR setting IDs as specified herein in the present disclosure—could be associated to/with the first CSI reporting configuration and/or the CSI reporting configuration with the lowest CSI reporting configuration ID—e.g., among one or more CSI reporting configurations/CSI reporting configuration IDs as specified herein in the present disclosure, the SR setting with the second lowest (or second highest) SR setting ID—e.g., among the one or more SR settings/SR setting IDs as specified herein in the present disclosure—could be associated to/with the second CSI reporting configuration and/or the CSI reporting configuration with the second lowest CSI reporting configuration ID—e.g., among the one or more CSI reporting configurations/CSI reporting configuration IDs as specified herein in the present disclosure, and so on, and the SR setting with the highest (or lowest) SR setting ID—e.g., among the one or more SR settings/SR setting IDs as specified herein in the present disclosure—could be associated to/with the last CSI reporting configuration and/or the CSI reporting configuration with the highest CSI reporting configuration ID—e.g., among the one or more CSI reporting configurations/CSI reporting configuration IDs as specified herein in the present disclosure.
In yet another example, the UE could be indicated/configured/provided by the network, e.g., via higher layer RRC signaling(s)/parameter(s) and/or MAC CE command(s) and/or dynamic DCI based L1 signaling(s), mapping/association relation(s) between one or more SR settings (and therefore, the corresponding SR setting ID(s)) and one or more CSI reporting configurations (and therefore, the corresponding CSI reporting configuration ID(s)). For example, the UE could be indicated/configured/provided by the network, e.g., via higher layer RRC signaling(s)/parameter(s) and/or MAC CE command(s) and/or dynamic DCI based L1 signaling(s), a (look-up) table, wherein the SR setting ID(s)—and therefore, the corresponding SR setting(s)—and the CSI reporting configuration ID(s)—and therefore, the corresponding CSI reporting configuration(s)—in the same row of the table could be associated/linked to each other; furthermore, one or more entries/rows of the table could be updated by/via RRC (re-)configuration and/or MAC CE and/or DCI, e.g., in form of bitmap(s). For another example, the UE could be indicated/configured/provided by the network, e.g., via higher layer RRC signaling(s)/parameter(s) and/or MAC CE command(s) and/or dynamic DCI based L1 signaling(s), a set/list of SR setting ID(s) and a set/list of CSI reporting configuration ID(s) as specified herein in the present disclosure; for this case, the SR setting ID(s)—and therefore, the corresponding SR setting(s) as specified herein in the present disclosure—and the CSI reporting configuration ID(s)—and therefore, the corresponding CSI reporting configuration(s) as specified herein in the present disclosure—could be one-to-one mapped/associated following those described/specified in the present disclosure (e.g., those provided/specified in one or more examples described herein); furthermore, the set/list of SR setting ID(s) and/or the set/list of CSI reporting configuration ID(s) could be updated by/via RRC (re-)configuration and/or MAC CE and/or DCI, e.g., in form of bitmap(s). Yet for another example, the UE could be indicated/configured/provided by the network, e.g., via higher layer RRC signaling(s)/parameter(s) and/or MAC CE command(s) and/or dynamic DCI based L1 signaling(s), a first bitmap with each entry/bit position of the first bitmap corresponding/associated to a SR setting ID/SR setting as specified herein in the present disclosure, and/or a second bitmap with each entry/bit position of the second bitmap corresponding/associated to a CSI reporting configuration ID/CSI reporting configuration as specified herein in the present disclosure—the first bitmap and the second bitmap could be identical or different; for this case, the SR setting ID(s)/SR setting(s) with their corresponding/associated entry(s)/bit position(s) in the first bitmap set to ‘1’ (or ‘0’) and the CSI reporting configuration ID(s)/CSI reporting configuration(s) with their corresponding/associated entry(s)/bit position(s) in the second bitmap set to ‘1’ (or ‘0’) could be one-to-one mapped/associated following those described/specified in the present disclosure (e.g., those provided/specified in one or more examples described herein); furthermore, the first and/or the second bitmap(s) could be updated by/via RRC (re-)configuration and/or MAC CE and/or DCI, e.g., in form of bitmap(s).
In yet another example, the UE could receive from the network, e.g., a RRC signaling/parameter and/or a MAC CE command and/or a DCI signaling/format, that provides/indicates/configures one or more SR settings/SR setting IDs. When/if the RRC signaling/parameter and/or the MAC CE command and/or the DCI signaling/format as specified herein in the present disclosure also provides/indicates/configures one or more CSI reporting configurations/CSI reporting configuration IDs, the one or more SR settings/SR setting IDs and the one or more CSI reporting configurations/CSI reporting configuration IDs provided/indicated/configured in the same RRC signaling/parameter and/or MAC CE command and/or DCI signaling/format could be one-to-one mapped/associated following those described/specified in the present disclosure (e.g., those provided/specified in one or more examples described herein).
In yet another example, the UE could receive from the network, e.g., a RRC signaling/parameter and/or a MAC CE command and/or a DCI signaling/format, that provides/indicates/configures one or more CSI reporting configurations/CSI reporting configuration IDs. When/if the RRC signaling/parameter and/or the MAC CE command and/or the DCI signaling/format as specified herein in the present disclosure also provides/indicates/configures one or more SR settings/SR setting IDs, the one or more CSI reporting configurations/CSI reporting configuration IDs and the one or more SR settings/SR setting IDs provided/indicated/configured in the same RRC signaling/parameter and/or MAC CE command and/or DCI signaling/format could be one-to-one mapped/associated following those described/specified in the present disclosure (e.g., those provided/specified in one or more examples described herein).
In yet another example, a RRC signaling/parameter and/or a MAC CE command and/or a DCI signaling/format that configures/provides/indicates a SR setting/SR setting ID as specified herein in the present disclosure (e.g., the higher layer RRC signaling/parameter SchedulingRequestConfig that configures/provides/indicates a SR configuration) could also configure/provide/indicate one or more CSI reporting configurations/CSI reporting configuration IDs as specified herein in the present disclosure (e.g., the higher layer parameter(s) CSI-ReportConfig and/or CSI-AssociatedReportConfigInfo and/or CSI-AperiodicTriggerState). For this case, the SR setting/SR setting ID (e.g., a SR configuration provided by SchedulingRequestConfig) could be mapped/associated to the one or more CSI reporting configurations/CSI reporting configuration IDs (e.g., one or more CSI reporting settings each provided by CSI-ReportConfig and/or CSI-AssociatedReportConfigInfo and/or CSI-AperiodicTriggerState) provided/indicated/configured in the same RRC signaling/parameter and/or MAC CE command and/or DCI signaling/format as specified herein in the present disclosure.
In yet another example, a RRC signaling/parameter and/or a MAC CE command and/or a DCI signaling/format that configures/provides/indicates a CSI reporting configuration/CSI reporting configuration ID as specified herein in the present disclosure (e.g., the higher layer RRC signaling/parameter CSI-ReportConfig and/or CSI-AssociatedReportConfigInfo and/or CSI-AperiodicTriggerState that configures/provides/indicates a CSI reporting setting) could also configure/provide/indicate one or more SR settings/SR setting IDs as specified herein in the present disclosure (e.g., the higher layer parameter(s) SchedulingRequestId). For this case, the CSI reporting configuration/CSI reporting configuration ID (e.g., a CSI reporting setting provided by CSI-ReportConfig and/or CSI-AssociatedReportConfigInfo and/or CSI-AperiodicTriggerState) could be mapped/associated to the one or more SR settings/SR setting IDs (e.g., one or more SR resources each provided by SchedulingRequestId) provided/indicated/configured in the same RRC signaling/parameter and/or MAC CE command and/or DCI signaling/format as specified herein in the present disclosure.
In yet another example, a first RRC signaling/parameter and/or a first MAC CE command and/or a first DCI signaling/format that configures/provides/indicates a SR setting/SR setting ID as specified herein in the present disclosure (e.g., a SR resource provided by SchedulingRequestId) could also configure/provide/indicate a first indicator. In addition, a second RRC signaling/parameter and/or a second MAC CE command and/or a second DCI signaling/format that configures/provides/indicates a CSI reporting configuration/CSI reporting configuration ID as specified herein in the present disclosure (e.g., a CSI reporting setting provided by CSI-ReportConfig and/or CSI-AssociatedReportConfigInfo and/or CSI-AperiodicTriggerState) could also configure/provide/indicate a second indicator. When/if the first indicator and the second indicator are set to the same value(s) such as ‘1’ (or ‘0’), ‘enabled’ (or ‘disabled’), ‘00’ (or ‘01’, ‘10’, ‘11’), ‘on’ (or ‘off’), and/or etc., the SR setting/SR setting ID (e.g., the SR resource provided by SchedulingRequestId) provided/indicated/configured in/by the first RRC signaling/parameter and/or the first MAC CE command and/or the first DCI signaling/format could be associated/mapped to the CSI reporting configuration/CSI reporting configuration ID (e.g., the CSI reporting setting provided by CSI-ReportConfig and/or CSI-AssociatedReportConfigInfo and/or CSI-AperiodicTriggerState) provided/indicated/configured in/by the second RRC signaling/parameter and/or the second MAC CE command and/or the second DCI signaling/format.

The association(s)/mapping(s) between one or more SR settings/SR setting IDs and one or more IDs CSI reporting configurations/CSI reporting configuration determined/configured/indicated/provided according to those specified/defined/described in the present disclosure, e.g., those provided/specified in one or more examples described herein, could also be autonomously determined/selected/decided by the UE, which could be further reported by the UE to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc. In addition, the association(s)/mapping(s) between one or more SR settings/SR setting IDs and one or more CSI reporting configurations/CSI reporting configuration IDs determined/configured/indicated/provided according to those specified/defined/described in the present disclosure, e.g., those provided/specified in one or more examples described herein, could be applied/extended to associating/mapping between one or more SR settings/SR setting IDs and one or more parameters/quantities provided/configured in the one or more CSI reporting configurations, e.g., by replacing the CSI reporting configuration(s)/CSI reporting configuration ID(s) in one or more examples described herein by/with the one or more parameters/quantities provided/configured in the one or more CSI reporting configurations.

In one embodiment, a PUCCH resource setting as specified herein in the present disclosure could be associated to/with one or more CSI resource/reporting configurations as specified herein in the present disclosure, e.g., according to: (i) fixed rule(s)/value(s) in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous selection/determination, which could be further sent to the network, e.g., via/in part of a CSI/beam report and/or UE's capability signaling(s).
In one example, the first (or last) PUCCH resource setting—e.g., among one or more PUCCH resource settings as specified herein in the present disclosure—could be associated to/with the first CSI resource/reporting configuration and/or the CSI resource/reporting configuration with the lowest CSI resource/reporting configuration ID—e.g., among one or more CSI resource/reporting configurations/CSI resource/reporting configuration IDs as specified herein in the present disclosure, the second (or second last) PUCCH resource setting—e.g., among the one or more PUCCH resource settings as specified herein in the present disclosure—could be associated to/with the second CSI resource/reporting configuration and/or the CSI resource/reporting configuration with the second lowest CSI resource/reporting configuration ID—e.g., among the one or more CSI resource/reporting configurations/CSI resource/reporting configuration IDs as specified herein in the present disclosure, and so on, and the last (or first) PUCCH resource setting—e.g., among the one or more PUCCH resource settings as specified herein in the present disclosure—could be associated to/with the last CSI resource/reporting configuration and/or the CSI resource/reporting configuration with the highest CSI resource/reporting configuration ID—e.g., among the one or more CSI resource/reporting configurations/CSI resource/reporting configuration IDs as specified herein in the present disclosure.
In another example, the PUCCH resource setting with the lowest (or highest) PUCCH resource setting ID—e.g., among one or more PUCCH resource settings/PUCCH resource setting IDs as specified herein in the present disclosure—could be associated to/with the first CSI resource/reporting configuration and/or the CSI resource/reporting configuration with the lowest CSI resource/reporting configuration ID—e.g., among one or more CSI resource/reporting configurations/CSI resource/reporting configuration IDs as specified herein in the present disclosure, the PUCCH resource setting with the second lowest (or second highest) PUCCH resource setting ID—e.g., among the one or more PUCCH resource settings/PUCCH resource setting IDs as specified herein in the present disclosure—could be associated to/with the second CSI resource/reporting configuration and/or the CSI resource/reporting configuration with the second lowest CSI resource/reporting configuration ID—e.g., among the one or more CSI resource/reporting configurations/CSI resource/reporting configuration IDs as specified herein in the present disclosure, and so on, and the PUCCH resource setting with the highest (or lowest) PUCCH resource setting ID—e.g., among the one or more PUCCH resource settings/PUCCH resource setting IDs as specified herein in the present disclosure—could be associated to/with the last CSI resource/reporting configuration and/or the CSI resource/reporting configuration with the highest CSI resource/reporting configuration ID—e.g., among the one or more CSI resource/reporting configurations/CSI resource/reporting configuration IDs as specified herein in the present disclosure.
In yet another example, the UE could be indicated/configured/provided by the network, e.g., via higher layer RRC signaling(s)/parameter(s) and/or MAC CE command(s) and/or dynamic DCI based L1 signaling(s), mapping/association relation(s) between one or more PUCCH resource settings (and therefore, the corresponding PUCCH resource setting ID(s)) and one or more CSI resource/reporting configurations (and therefore, the corresponding CSI resource/reporting configuration ID(s)). For example, the UE could be indicated/configured/provided by the network, e.g., via higher layer RRC signaling(s)/parameter(s) and/or MAC CE command(s) and/or dynamic DCI based L1 signaling(s), a (look-up) table, wherein the PUCCH resource setting ID(s)—and therefore, the corresponding PUCCH resource setting(s)—and the CSI resource/reporting configuration ID(s)—and therefore, the corresponding CSI resource/reporting configuration(s)—in the same row of the table could be associated/linked to each other; furthermore, one or more entries/rows of the table could be updated by/via RRC (re-)configuration and/or MAC CE and/or DCI, e.g., in form of bitmap(s). For another example, the UE could be indicated/configured/provided by the network, e.g., via higher layer RRC signaling(s)/parameter(s) and/or MAC CE command(s) and/or dynamic DCI based L1 signaling(s), a set/list of PUCCH resource setting ID(s) and a set/list of CSI resource/reporting configuration ID(s) as specified herein in the present disclosure; for this case, the PUCCH resource setting ID(s)—and therefore, the corresponding PUCCH resource setting(s) as specified herein in the present disclosure—and the CSI resource/reporting configuration ID(s)—and therefore, the corresponding CSI resource/reporting configuration(s) as specified herein in the present disclosure—could be one-to-one mapped/associated following those described/specified in the present disclosure (e.g., those provided/specified in one or more examples described herein); furthermore, the set/list of PUCCH resource setting ID(s) and/or the set/list of CSI resource/reporting configuration ID(s) could be updated by/via RRC (re-)configuration and/or MAC CE and/or DCI, e.g., in form of bitmap(s). Yet for another example, the UE could be indicated/configured/provided by the network, e.g., via higher layer RRC signaling(s)/parameter(s) and/or MAC CE command(s) and/or dynamic DCI based L1 signaling(s), a first bitmap with each entry/bit position of the first bitmap corresponding/associated to a PUCCH resource setting ID/PUCCH resource setting as specified herein in the present disclosure, and/or a second bitmap with each entry/bit position of the second bitmap corresponding/associated to a CSI resource/reporting configuration ID/CSI resource/reporting configuration as specified herein in the present disclosure—the first bitmap and the second bitmap could be identical or different; for this case, the PUCCH resource setting ID(s)/PUCCH resource setting(s) with their corresponding/associated entry(s)/bit position(s) in the first bitmap set to ‘1’ (or ‘0’) and the CSI resource/reporting configuration ID(s)/CSI resource/reporting configuration(s) with their corresponding/associated entry(s)/bit position(s) in the second bitmap set to ‘1’ (or ‘0’) could be one-to-one mapped/associated following those described/specified in the present disclosure (e.g., those provided/specified in one or more examples described herein); furthermore, the first and/or the second bitmap(s) could be updated by/via RRC (re-)configuration and/or MAC CE and/or DCI, e.g., in form of bitmap(s).
In yet another example, the UE could receive from the network, e.g., a RRC signaling/parameter and/or a MAC CE command and/or a DCI signaling/format, that provides/indicates/configures one or more PUCCH resource settings/PUCCH resource setting IDs. When/if the RRC signaling/parameter and/or the MAC CE command and/or the DCI signaling/format as specified herein in the present disclosure also provides/indicates/configures one or more CSI resource/reporting configurations/CSI resource/reporting configuration IDs, the one or more PUCCH resource settings/PUCCH resource setting IDs and the one or more CSI resource/reporting configurations/CSI resource/reporting configuration IDs provided/indicated/configured in the same RRC signaling/parameter and/or MAC CE command and/or DCI signaling/format could be one-to-one mapped/associated following those described/specified in the present disclosure (e.g., those provided/specified in one or more examples described herein).
In yet another example, the UE could receive from the network, e.g., a RRC signaling/parameter and/or a MAC CE command and/or a DCI signaling/format, that provides/indicates/configures one or more CSI resource/reporting configurations/CSI resource/reporting configuration IDs. When/if the RRC signaling/parameter and/or the MAC CE command and/or the DCI signaling/format as specified herein in the present disclosure also provides/indicates/configures one or more PUCCH resource settings/PUCCH resource setting IDs, the one or more CSI resource/reporting configurations/CSI resource/reporting configuration IDs and the one or more PUCCH resource settings/PUCCH resource setting IDs provided/indicated/configured in the same RRC signaling/parameter and/or MAC CE command and/or DCI signaling/format could be one-to-one mapped/associated following those described/specified in the present disclosure (e.g., those provided/specified in one or more examples described herein).
In yet another example, a RRC signaling/parameter and/or a MAC CE command and/or a DCI signaling/format that configures/provides/indicates a PUCCH resource setting/PUCCH resource setting ID as specified herein in the present disclosure (e.g., the higher layer RRC signaling/parameter PUCCH-Config that configures/provides/indicates a PUCCH resource configuration) could also configure/provide/indicate one or more CSI resource/reporting configurations/CSI resource/reporting configuration IDs as specified herein in the present disclosure (e.g., the higher layer parameter(s) CSI-ReportConfig/CSI-ResourceConfig and/or CSI-AssociatedReportConfigInfo and/or CSI-AperiodicTriggerState and/or NZP-CSI-RS-ResourceSet). For this case, the PUCCH resource setting/PUCCH resource setting ID (e.g., a PUCCH resource configuration provided by PUCCH-Config) could be mapped/associated to the one or more CSI resource/reporting configurations/CSI resource/reporting configuration IDs (e.g., one or more CSI reporting settings each provided by CSI-ReportConfig and/or CSI-AssociatedReportConfigInfo and/or CSI-Aperiodic TriggerState) provided/indicated/configured in the same RRC signaling/parameter and/or MAC CE command and/or DCI signaling/format as specified herein in the present disclosure.
In yet another example, a RRC signaling/parameter and/or a MAC CE command and/or a DCI signaling/format that configures/provides/indicates a CSI resource/reporting configuration/CSI resource/reporting configuration ID as specified herein in the present disclosure (e.g., the higher layer RRC signaling/parameter CSI-ReportConfig/CSI-ResourceConfig and/or CSI-AssociatedReportConfigInfo and/or CSI-AperiodicTriggerState that configures/provides/indicates a CSI reporting/resource setting) could also configure/provide/indicate one or more PUCCH resource settings/PUCCH resource setting IDs as specified herein in the present disclosure (e.g., the higher layer parameter(s) PUCCH-ResourceId). For this case, the CSI resource/reporting configuration/CSI resource/reporting configuration ID (e.g., a CSI reporting setting provided by CSI-ReportConfig and/or CSI-AssociatedReportConfigInfo and/or CSI-AperiodicTriggerState) could be mapped/associated to the one or more PUCCH resource settings/PUCCH resource setting IDs (e.g., one or more PUCCH resources each provided by PUCCH-ResourceId) provided/indicated/configured in the same RRC signaling/parameter and/or MAC CE command and/or DCI signaling/format as specified herein in the present disclosure.
In yet another example, a first RRC signaling/parameter and/or a first MAC CE command and/or a first DCI signaling/format that configures/provides/indicates a PUCCH resource setting/PUCCH resource setting ID as specified herein in the present disclosure (e.g., a PUCCH resource provided by PUCCH-Resource) could also configure/provide/indicate a first indicator. In addition, a second RRC signaling/parameter and/or a second MAC CE command and/or a second DCI signaling/format that configures/provides/indicates a CSI resource/reporting configuration/CSI resource/reporting configuration ID as specified herein in the present disclosure (e.g., a CSI reporting setting provided by CSI-ReportConfig and/or CSI-AssociatedReportConfigInfo and/or CSI-AperiodicTriggerState) could also configure/provide/indicate a second indicator. When/if the first indicator and the second indicator are set to the same value(s) such as ‘1’ (or ‘0’), ‘enabled’ (or ‘disabled’), ‘00’ (or ‘01’, ‘10’, ‘11’), ‘on’ (or ‘off’), and/or etc., the PUCCH resource setting/PUCCH resource setting ID (e.g., the PUCCH resource provided by PUCCH-Resource) provided/indicated/configured in/by the first RRC signaling/parameter and/or the first MAC CE command and/or the first DCI signaling/format could be associated/mapped to the CSI resource/reporting configuration/CSI resource/reporting configuration ID (e.g., the CSI reporting setting provided by CSI-ReportConfig and/or CSI-AssociatedReportConfigInfo and/or CSI-AperiodicTriggerState) provided/indicated/configured in/by the second RRC signaling/parameter and/or the second MAC CE command and/or the second DCI signaling/format.

The association(s)/mapping(s) between one or more PUCCH resource settings/PUCCH resource setting IDs and one or more CSI resource/reporting configurations/CSI resource/reporting configuration IDs determined/configured/indicated/provided according to those specified/defined/described in the present disclosure, e.g., those provided/specified in one or more examples described herein, could also be autonomously determined/selected/decided by the UE, which could be further reported by the UE to the network, e.g., along with the transmission(s) of the SR(s) and/or in/via part of a beam/CSI report and/or in/via UE's capability signaling(s) and/or in/via corresponding PUCCH(s)/PUSCH(s)/PRACH(s)/etc. A SR setting/SR setting ID could be associated with/to one or more PUCCH resource settings/PUCCH resource setting IDs, and therefore, one or more CSI resource/reporting settings and/or CSI resource/reporting setting IDs that are associated to/with the one or more PUCCH resource settings/PUCCH resource setting IDs according to those specified herein in the present disclosure (e.g., those provided in one or more examples described herein). In addition, the association(s)/mapping(s) between one or more PUCCH resource settings/PUCCH resource setting IDs and one or more CSI resource/reporting configurations/CSI resource/reporting configuration IDs determined/configured/indicated/provided according to those specified/defined/described in the present disclosure, e.g., those provided/specified in one or more examples described herein, could be applied/extended to associating/mapping between one or more PUCCH resource settings/PUCCH resource setting IDs and one or more parameters/quantities provided/configured in the one or more CSI resource/reporting configurations, e.g., by replacing the CSI resource/reporting configuration(s)/CSI resource/reporting configuration ID(s) in one or more examples described herein by/with the one or more parameters/quantities provided/configured in the one or more CSI resource/reporting configurations.

A UE could determine/identity one or more SR settings/SR setting IDs and/or one or more PUCCH resource settings/PUCCH resource setting IDs as specified herein in the present disclosure (and therefore, their corresponding/associated CSI resource configuration(s) and/or CSI reporting configuration(s) as specified herein in the present disclosure) to send SR(s) to trigger or initiate or indicate P/SP/AP CSI-RS(s) measurement and/or reporting and/or TCI state(s)/beam(s) activation/deactivation/sub-selection and/or TCI state(s)/beam(s) switching/change/update according to those specified herein in the present disclosure, according to one or more of:
Purpose(s) or content(s) of the SR(s): e.g., when/if the SR(s) is used for triggering or initiating or indicating P/SP/AP CSI-RS(s) measurement and/or reporting as specified herein in the present disclosure, the UE could determine/identify a first SR setting/SR setting ID and/or a first PUCCH resource setting/PUCCH resource setting ID, and therefore, the CSI resource/reporting configuration(s) associated/corresponding to the determined/identified first SR setting/SR setting ID and/or the determined/identified first PUCCH resource setting/PUCCH resource setting ID as specified herein in the present disclosure, and/or when/if the SR(s) is used for triggering or initiating or indicating TCI state(s)/beam(s) activation/deactivation/sub-selection as specified herein in the present disclosure, the UE could determine/identify a second SR setting/SR setting ID and/or a second PUCCH resource setting/PUCCH resource setting ID, and therefore, the CSI resource/reporting configuration(s) associated/corresponding to the determined/identified second SR setting/SR setting ID and/or the determined/identified second PUCCH resource setting/PUCCH resource setting ID as specified herein in the present disclosure, and/or when/if the SR(s) is used for triggering or initiating or indicating TCI state(s)/beam(s) switching/change/update as specified herein in the present disclosure, the UE could determine/identify a third SR setting/SR setting ID and/or a third PUCCH resource setting/PUCCH resource setting ID, and therefore, the CSI resource/reporting configuration(s) associated/corresponding to the determined/identified third SR setting/SR setting ID and/or the determined/identified third PUCCH resource setting/PUCCH resource setting ID as specified herein in the present disclosure. In this case/design example, the determined/identified first, second and third SR settings/SR setting IDs could be the same or different, and their associations to/with different purpose(s) or content(s) of the SR(s) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s). And/or, the determined/identified first, second and third PUCCH resource settings/PUCCH resource setting IDs could be the same or different, and their associations to/with different purpose(s) or content(s) of the SR(s) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s).
Payload size(s) of the report(s) associated/corresponding to the SR(s): e.g., for a SR used for triggering or initiating or indicating P/SP/AP CSI-RS(s) measurement and/or reporting and/or TCI state(s)/beam(s) activation/deactivation/sub-selection and/or TCI state(s)/beam(s) switching/update/change according to those specified herein in the present disclosure, when/if, e.g., payload size of the report(s) associated/corresponding to the SR is greater than x1 but less than x2, the UE could determine/identify a SR setting/SR setting ID and/or a PUCCH resource setting/PUCCH resource setting ID associated/corresponding to x1 and/or x2 and/or the payload size of the report(s) associated/corresponding to the SR, and therefore, the CSI resource/reporting configuration(s) associated/corresponding to the determined/identified SR setting/SR setting ID and/or the determined/identified PUCCH resource setting/PUCCH resource setting ID as specified herein in the present disclosure. The value(s) of x1 and/or x2, and/or the association/correspondence between the value(s) of x1 and/or x2 and the SR setting(s)/SR setting ID(s)/PUCCH resource setting(s)/PUCCH resource setting ID(s), and/or the association/correspondence between the payload size(s) of the report(s) associated/corresponding to the SR(s) and the SR setting(s)/SR setting ID(s)/PUCCH resource setting(s)/PUCCH resource setting ID(s) could be: (i) determined according to fixed value(s)/rule(s) in system specification(s), (ii) provided/indicated/configured by the network, e.g., via higher layer RRC signaling(s)/parameter(s) and/or MAC CE command(s) and/or dynamic DCI based L1 signaling(s), and/or (iii) autonomously determined by the UE, which could be further reported to the network, e.g., in/via part of a/the CSI/beam report and/or UE's capability signaling(s). The UE could first send to the network one or more SRs to trigger or initiate or indicate P/SP/AP CSI-RS(s) measurement and/or reporting and/or TCI state(s)/beam(s) activation/deactivation/sub-selection and/or TCI state(s)/beam(s) switching/update/change according to those specified herein in the present disclosure; upon receiving network's response (e.g., an acknowledgement (ACK)/negative ACK (NACK) or UL grant) with respect to the SR(s), the UE could send to the network the report(s) associated/corresponding to the SR(s), e.g., via the scheduled/granted UL channels/signals/resources.
Type(s) of the SR(s): e.g., when/if the SR(s) is only used as a pre-notification message as specified herein in the present disclosure, the UE (e.g. the UE 116) could determine/identify a first SR setting/SR setting ID and/or a first PUCCH resource setting/PUCCH resource setting ID, and therefore, the CSI resource/reporting configuration(s) associated/corresponding to the determined/identified first SR setting/SR setting ID and/or the determined/identified first PUCCH resource setting/PUCCH resource setting ID as specified herein in the present disclosure, and/or when/if the SR(s) is sent to require UL grant/assignment/ACK/NACK for PUSCH/MAC CE to carry report(s) associated/corresponding to the SR(s), the UE could determine/identify a second SR setting/SR setting ID and/or a second PUCCH resource setting/PUCCH resource setting ID, and therefore, the CSI resource/reporting configuration(s) associated/corresponding to the determined/identified second SR setting/SR setting ID and/or the determined/identified second PUCCH resource setting/PUCCH resource setting ID as specified herein in the present disclosure, and/or when/if the SR(s) is sent to require UL grant/assignment/ACK/NACK for PUCCH(s) to carry report(s) associated/corresponding to the SR(s), the UE could determine/identify a third SR setting/SR setting ID and/or a third PUCCH resource setting/PUCCH resource setting ID, and therefore, the CSI resource/reporting configuration(s) associated/corresponding to the determined/identified third SR setting/SR setting ID and/or the determined/identified third PUCCH resource setting/PUCCH resource setting ID as specified herein in the present disclosure. In this case/design example, the determined/identified first, second and third SR settings/SR setting IDs could be the same or different, and their associations to/with different types of the SR(s) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s). And/or, the determined/identified first, second and third PUCCH resource settings/PUCCH resource setting IDs could be the same or different, and their associations to/with different types of the SR(s) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s).

As specified herein in the present disclosure, the UE could send to the network (e.g. the network 130) one or more SRs via one or more SR configurations: (1) to trigger or initiate, e.g., P/SP/AP CSI-RS(s) measurement and/or reporting (e.g., for CSI acquisition and/or beam management and/or etc.) and/or TCI state(s)/beam(s) activation/deactivation/sub-selection and/or TCI state(s)/beam(s) switching/change/update and/or etc. according to those specified herein in the present disclosure, wherein for this case, the SR(s) could be used as trigger(s)/pre-notification message(s) without the follow-up/corresponding content(s)/report(s) associated/corresponding to the SR(s)/SR configuration(s), (2) to request UL grant/acknowledgement/etc. for PUSCH/MAC CE to carry/send the follow-up/corresponding content(s)/report(s) associated/corresponding to the SR(s)/SR configuration(s), and/or (3) to request UL grant/acknowledgement/etc. for PUCCH to carry/send the follow-up/corresponding content(s)/report(s) associated/corresponding to the SR(s)/SR configuration(s), wherein according to those specified herein in the present disclosure, the follow-up content(s)/report(s) could contain/comprise/include/provide or could correspond to information related to (i) P/SP/AP CSI-RS(s) measurement and/or reporting, (iii) TCI state(s)/beam(s) activation/deactivation/sub-selection, and/or (iii) TCI state(s)/beam(s) switching/change/update.
In one example, one or more fourth SRs (or SR IDs) or one or more fourth SR configurations (or SR configuration IDs) could be associated to/with or could be used to trigger or initiate, e.g., P/SP/AP CSI-RS(s) measurement and/or reporting (e.g., for CSI acquisition and/or beam management and/or etc.) and/or TCI state(s)/beam(s) activation/deactivation/sub-selection and/or TCI state(s)/beam(s) switching/change/update and/or etc. according to those specified herein in the present disclosure, wherein for this case, the fourth SR(s) could be used as trigger(s)/pre-notification message(s) without the follow-up/corresponding content(s)/report(s) associated/corresponding to the fourth SR(s)/SR configuration(s), e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s). The determination(s)/selection(s)/configuration(s)/indication(s) of the one or more fourth SRs (or SR IDs) and/or the one or more fourth SR configurations (or SR configuration IDs) could follow those specified/defined in the present disclosure (e.g., those specified in one or more examples described herein) for the determination(s)/selection(s)/configuration(s)/indication(s) of the one or more first SRs (or SR IDs) and/or the one or more first SR configurations (or SR configuration IDs) for indicating/triggering/initiating P/SP/AP CSI-RS(s) measurement and/or reporting as specified herein in the present disclosure, e.g., by replacing the first SR(s)/SR ID(s) with the fourth SR(s)/SR ID(s), the first SR configuration(s)/SR configuration ID(s) with the fourth SR configuration(s)/SR configuration ID(s), ‘ueInitiatedBeamReporting’ with ‘preNotificationSR’, the function/objective/operation/use of triggering/initiating/indicating/requesting P/SP/AP CSI-RS(s) measurement and/or reporting with the function/objective/operation/use of trigger(s)/pre-notification message(s) without follow-up/corresponding content(s)/report(s) associated/corresponding to the fourth SR(s)/fourth SR configuration(s), first PUCCH resource(s)/PUCCH resource ID(s) with fourth PUCCH resource(s)/PUCCH resource ID(s), first PUCCH resource group(s)/PUCCH resource group ID(s) with fourth PUCCH resource group(s)/PUCCH resource group ID(s), and/or first PUCCH resource set(s)/PUCCH resource set ID(s) with fourth PUCCH resource set(s)/PUCCH resource set ID(s).
In another example, one or more fifth SRs (or SR IDs) or one or more fifth SR configurations (or SR configuration IDs) could be associated to/with or could be used to trigger or initiate or request UL grant/acknowledgement/etc. for PUSCH/MAC CE to send/carry the follow-up content(s)/report(s) corresponding/associated to the fifth SR(s)/fifth SR configuration(s), e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a CSI/beam report and/or UE's capability signaling(s). The determination(s)/selection(s)/configuration(s)/indication(s) of the one or more fifth SRs (or SR IDs) and/or the one or more fifth SR configurations (or SR configuration IDs) could follow those specified/defined in the present disclosure (e.g., those specified in one or more examples described herein) for the determination(s)/selection(s)/configuration(s)/indication(s) of the one or more first SRs (or SR IDs) and/or the one or more first SR configurations (or SR configuration IDs) for indicating/triggering/initiating P/SP/AP CSI-RS(s) measurement and/or reporting as specified herein in the present disclosure, e.g., by replacing the first SR(s)/SR ID(s) with the fifth SR(s)/SR ID(s), the first SR configuration(s)/SR configuration ID(s) with the fifth SR configuration(s)/SR configuration ID(s), ‘ueInitiatedBeamReporting’ with ‘SRforPUSCH’, the function/objective/operation/use of triggering/initiating/indicating/requesting P/SP/AP CSI-RS(s) measurement and/or reporting with the function/objective/operation/use of requesting UL grant/ACK/etc. for PUSCH/MAC CE to send/carry the follow-up content(s)/report(s) corresponding/associated to the fifth SR(s)/fifth SR configuration(s), first PUCCH resource(s)/PUCCH resource ID(s) with fifth PUCCH resource(s)/PUCCH resource ID(s), first PUCCH resource group(s)/PUCCH resource group ID(s) with fifth PUCCH resource group(s)/PUCCH resource group ID(s), and/or first PUCCH resource set(s)/PUCCH resource set ID(s) with fifth PUCCH resource set(s)/PUCCH resource set ID(s).
In yet another example, one or more sixth SRs (or SR IDs) or one or more sixth SR configurations (or SR configuration IDs) could be associated to/with or could be used to trigger or initiate or request UL grant/acknowledgement/etc. for PUCCH to send/carry the follow-up content(s)/report(s) corresponding/associated to the sixth SR(s)/sixth SR configuration(s), e.g., according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via CSI/beam report part of a and/or UE's capability signaling(s). The determination(s)/selection(s)/configuration(s)/indication(s) of the one or more sixth SRs (or SR IDs) and/or the one or more sixth SR configurations (or SR configuration IDs) could follow those specified/defined in the present disclosure (e.g., those specified in one or more examples described herein) for the determination(s)/selection(s)/configuration(s)/indication(s) of the one or more first SRs (or SR IDs) and/or the one or more first SR configurations (or SR configuration IDs) for indicating/triggering/initiating P/SP/AP CSI-RS(s) measurement and/or reporting as specified herein in the present disclosure, e.g., by replacing the first SR(s)/SR ID(s) with the sixth SR(s)/SR ID(s), the first SR configuration(s)/SR configuration ID(s) with the sixth SR configuration(s)/SR configuration ID(s), ‘ueInitiatedBeamReporting’ with ‘SRforPUCCH’, the function/objective/operation/use of triggering/initiating/indicating/requesting P/SP/AP CSI-RS(s) measurement and/or reporting with the function/objective/operation/use of requesting UL grant/ACK/etc. for PUCCH to send/carry the follow-up content(s)/report(s) corresponding/associated to the sixth SR(s)/sixth SR configuration(s), first PUCCH resource(s)/PUCCH resource ID(s) with sixth PUCCH resource(s)/PUCCH resource ID(s), first PUCCH resource group(s)/PUCCH resource group ID(s) with sixth PUCCH resource group(s)/PUCCH resource group ID(s), and/or first PUCCH resource set(s)/PUCCH resource set ID(s) with sixth PUCCH resource set(s)/PUCCH resource set ID(s).
In yet another example, the SR(s) as specified herein in the present disclosure could be of x-bit (e.g., x=1 or 2); the value(s) of x could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s).
   For example, the SR could be a one-bit indicator. In one example, when/if the SR is set to ‘0’ (or ‘1’), the SR could correspond to a fourth SR as specified herein in the present disclosure used as a trigger/pre-notification message, and/or when/if the SR is set to ‘1’ (or ‘0’), the SR could correspond to a fifth SR as specified herein in the present disclosure to request UL grant/ACK/etc. for PUSCH. In another example, when/if the SR is set to ‘0’ (or ‘1’), the SR could correspond to a fourth SR as specified herein in the present disclosure used as a trigger/pre-notification message, and/or when/if the SR is set to ‘1’ (or ‘0’), the SR could correspond to a sixth SR as specified herein in the present disclosure to request UL grant/ACK/etc. for PUCCH. In yet another example, when/if the SR is set to ‘0’ (or ‘1’), the SR could correspond to a fifth SR as specified herein in the present disclosure to request UL grant/ACK/etc. for PUSCH, and/or when/if the SR is set to ‘1’ (or ‘0’), the SR could correspond to a sixth SR as specified herein in the present disclosure to request UL grant/ACK/etc. for PUCCH.
   For another example, the SR could be a multi-bit indicator (e.g., x=2). E.g., when/if the SR is set to ‘00’ (or ‘01’ or ‘10’ or ‘11’), the SR could correspond to a fourth SR as specified herein in the present disclosure used as a trigger/pre-notification message, and/or when/if the SR is set to ‘01’ (or ‘00’ or ‘10’ or ‘11’), the SR could correspond to a fifth SR as specified herein in the present disclosure to request UL grant/ACK/etc. for PUSCH/MAC CE, and/or when/if the SR is set to ‘10’ (or ‘00’ or ‘01’ or ‘11’), the SR could correspond to a sixth SR as specified herein in the present disclosure to request UL grant/ACK/etc. for PUCCH.
In yet another example, the SR(s) as specified herein in the present disclosure could be of multi-level (e.g., y-level with y=1, 2, 3, 4) depending on/according to, e.g., payload size(s) of the SR(s); the value(s) of y could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s).
   For example, the SR could be of two-level. In one example, when/if the payload size of the SR is greater than or equal to y0 but less than or equal to y1 (i.e., the first level), the SR could correspond to a fourth SR as specified herein in the present disclosure used as a trigger/pre-notification message, and/or when/if the payload size of the SR is greater than or equal to y2 but less than or equal to y3 (i.e., the second level), the SR could correspond to a fifth SR as specified herein in the present disclosure to request UL grant/ACK/etc. for PUSCH/MAC CE. In another example, when/if the payload size of the SR is greater than or equal to y0 but less than or equal to y1 (i.e., the first level), the SR could correspond to a fourth SR as specified herein in the present disclosure used as a trigger/pre-notification message, and/or when/if the payload size of the SR is greater than or equal to y2 but less than or equal to y3 (i.e., the second level), the SR could correspond to a sixth SR as specified herein in the present disclosure to request UL grant/ACK/etc. for PUCCH. In yet another example, when/if the payload size of the SR is greater than or equal to y0 but less than or equal to y1 (i.e., the first level), the SR could correspond to a fifth SR as specified herein in the present disclosure to request UL grant/ACK/etc. for PUSCH/MAC CE, and/or when/if the payload size of the SR is greater than or equal to y2 but less than or equal to y3 (i.e., the second level), the SR could correspond to a sixth SR as specified herein in the present disclosure to request UL grant/ACK/etc. for PUCCH. The value(s) of y0, y1, y2 and/or y3 could be determined according to (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s). Furthermore, y2 could be greater than or equal to y1.
   For another example, the SR could be of three-level. E.g., when/if the payload size of the SR is greater than or equal to y0 but less than or equal to y1 (i.e., the first level), the SR could correspond to a fourth SR as specified herein in the present disclosure used as a trigger/pre-notification message (or a fifth SR as specified herein in the present disclosure to request UL grant/ACK/etc. for PUSCH/MAC CE or a sixth SR as specified herein in the present disclosure to request UL grant/ACK/etc. for PUCCH), and/or when/if the payload size of the SR is greater than or equal to y2 but less than or equal to y3 (i.e., the second level), the SR could correspond to a fifth SR as specified herein in the present disclosure to request UL grant/ACK/etc. for PUSCH/MAC CE (or a fourth SR as specified herein in the present disclosure used as a trigger/pre-notification message or a sixth SR as specified herein in the present disclosure to request UL grant/ACK/etc. for PUCCH), and/or when/if the payload size of the SR is greater than or equal to y4 but less than or equal to y5 (i.e., the third level), the SR could correspond to a sixth SR as specified herein in the present disclosure to request UL grant/ACK/etc. for PUCCH (or a fourth SR as specified herein in the present disclosure used as a trigger/pre-notification message or a fifth SR as specified herein in the present disclosure to request UL grant/ACK/etc. for PUSCH/MAC CE). The value(s) of y0, y1, y2, y3, y4 and/or y5 could be determined according to (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s). Furthermore, y2 could be greater than or equal to y1, and/or y4 could be greater than or equal to y3.
In yet another example, the SR(s) as specified herein in the present disclosure could be of or associated/corresponding to one or multiple (e.g., z=1, 2, 3) SR configurations. The value(s) of z could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a/the beam/CSI report and/or UE's capability signaling(s).
   For example, the UE could report to the network a capability of supporting two or more SR configurations (e.g., for the UE-initiated/triggered reporting and/or beam management as specified herein in the present disclosure), and could be configured/provided by the network a corresponding first SR configuration and a corresponding second SR configuration. In one example, when/if the SR corresponds to or is of or is via the first SR configuration as specified herein in the present disclosure, the SR could correspond to a fourth SR as specified herein in the present disclosure used as a trigger/pre-notification message, and/or when/if the SR corresponds to or is of or is via the second SR configuration as specified herein in the present disclosure, the SR could correspond to a fifth SR as specified herein in the present disclosure to request UL grant/ACK/etc. for PUSCH/MAC CE. In another example, when/if the SR corresponds to or is of or is via the first SR configuration as specified herein in the present disclosure, the SR could correspond to a fourth SR as specified herein in the present disclosure used as a trigger/pre-notification message, and/or when/if the SR corresponds to or is of or is via the second SR configuration as specified herein in the present disclosure, the SR could correspond to a sixth SR as specified herein in the present disclosure to request UL grant/ACK/etc. for PUCCH. In yet another example, when/if the SR corresponds to or is of or is via the first SR configuration as specified herein in the present disclosure, the SR could correspond to a fifth SR as specified herein in the present disclosure to request UL grant/ACK/etc. for PUSCH/MAC CE, and/or when/if the SR corresponds to or is of or is via the second SR configuration as specified herein in the present disclosure, the SR could correspond to a sixth SR as specified herein in the present disclosure to request UL grant/ACK/etc. for PUCCH.
   For another example, the UE could report to the network a capability of supporting three or more SR configurations (e.g., for the UE-initiated/triggered reporting and/or beam management as specified herein in the present disclosure), and could be configured/provided by the network a corresponding first SR configuration, a corresponding second SR configuration and a corresponding third SR configuration. E.g., when/if the SR corresponds to or is of or is via the first SR configuration as specified herein in the present disclosure, the SR could correspond to a fourth SR as specified herein in the present disclosure used as a trigger/pre-notification message (or a fifth SR as specified herein in the present disclosure to request UL grant/ACK/etc. for PUSCH/MAC CE or a sixth SR as specified herein in the present disclosure to request UL grant/ACK/etc. for PUCCH), and/or when/if the SR corresponds to or is of or is via the second SR configuration as specified herein in the present disclosure, the SR could correspond to a fifth SR as specified herein in the present disclosure to request UL grant/ACK/etc. for PUSCH/MAC CE (or a fourth SR as specified herein in the present disclosure used as a trigger/pre-notification message or a sixth SR as specified herein in the present disclosure to request UL grant/ACK/etc. for PUCCH), and/or when/if the SR corresponds to or is of or is via the third SR configuration as specified herein in the present disclosure, the SR could correspond to a sixth SR as specified herein in the present disclosure to request UL grant/ACK/etc. for PUCCH (or a fourth SR as specified herein in the present disclosure used as a trigger/pre-notification message or a fifth SR as specified herein in the present disclosure to request UL grant/ACK/etc. for PUSCH/MAC CE).

As specified herein in the present disclosure, after the UE has sent to the network a SR to request UL grant/ACK/etc. for PUSCH/MAC CE—e.g., a fifth SR as specified herein in the present disclosure, the UE could expect to receive the UL grant/ACK/etc. within a time window. Upon receiving the UL grant/ACK/etc. for the PUSCH/MAC CE, the UE would send to the network, e.g., via the granted/assigned/scheduled PUSCH/MAC CE (resources), content(s)/report(s) associated/corresponding to the SR. Furthermore, the UE could also expect to receive ACK/etc. for the content(s)/report(s) sent on the granted/assigned/scheduled PUSCH/MAC CE (resources) as specified herein in the present disclosure within a time window, wherein the ACK could be in form of or could correspond to a physical downlink control channel (PDCCH) reception with a DCI format scheduling a PUSCH transmission with a same HARQ process number as for the transmission of the granted/assigned/scheduled PUSCH/MAC CE that carries the content(s)/report(s) associated/corresponding to the SR and having a toggled new data indicator (NDI) field value, and the time window could be X symbols from a last symbol of the PDCCH reception. Here, the value of X could be determined according to: (1) fixed value(s)/rule(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous determination/selection, which could be further sent to the network, e.g., in/by part of a/the beam/CSI report and/or UE's capability signaling(s).

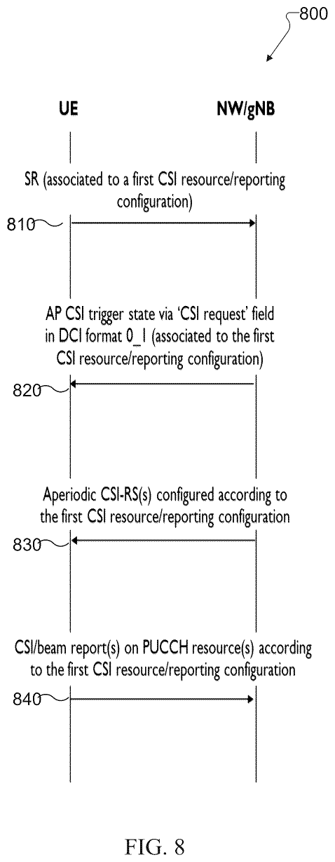

FIG. 8 illustrates a flowchart of an example procedure 800 for transmitting CSI/beam report(s) on PUCCH resource(s) according to embodiments of the present disclosure. For example, procedure 800 for transmitting CSI/beam report(s) on PUCCH resource(s) can be performed by the UE 116 and the gNB 102 and/or network 130 in the wireless network 100 of FIG. 1. This example is for illustration only and other embodiments can be used without departing from the scope of the present disclosure.

As specified herein in the present disclosure, after the UE has sent to the network a SR to request UL grant/ACK/etc. for PUCCH—e.g., a sixth SR as specified herein in the present disclosure, the UE could expect to receive the UL grant/ACK/etc. within a time window. Upon receiving the UL grant/ACK/etc. for the PUCCH, the UE would send to the network, e.g., via the PUCCH resource setting(s)/CSI resource configuration(s)/CSI reporting configuration(s) associated/corresponding to the SR and/or associated/corresponding to the SR setting(s) for the SR according to those specified herein in the present disclosure, content(s)/report(s) associated/corresponding to the SR. Alternatively, a UE could send to the network one or more SRs to deactivate and/or activate the PUCCH resource setting(s)—and therefore, the corresponding PUCCH resource(s)—and/or the CSI resource configuration(s) and/or the CSI reporting configuration(s) used to carry/provide the content(s)/report(s) according to those specified herein in the present disclosure. That is, the UE could send to the network one or more SRs to activate and/or deactivate one or more PUCCH resources in a semi-persistent manner, wherein the one or more PUCCH resources are used to carry/provide the content(s)/report(s) as specified herein in the present disclosure.

A UE could send to the network, e.g., within a time window, one or more fourth SRs as trigger(s)/pre-notification message(s)—without the follow-up/corresponding content(s)/report(s) associated/corresponding to the fourth SR(s)/SR configuration(s) as specified herein in the present disclosure, and/or one or more fifth SRs to request UL grant/ACK/etc. for PUSCH/MAC CE as specified herein in the present disclosure, and/or one or more sixth SRs to request UL grant/ACK/etc. for PUCCH as specified herein in the present disclosure. Alternatively, a UE could send to the network, e.g., within a time window, a multi-bit/multi-level SR as specified herein in the present disclosure as trigger/pre-notification message(s) and/or to request UL grant/ACK/etc. for PUSCH/MAC CE and/or to request UL grant/ACK/etc. for PUCCH. Whether to send multiple SRs or a single SR as trigger/pre-notification message(s) and/or to request UL grant/ACK/etc. for PUSCH/MAC CE and/or to request UL grant/ACK/etc. for PUCCH could be: (1) determined according to/based on fixed rule(s) in system specification(s), (2) configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further sent to the network, e.g., in/via part of a/the CSI/beam report and/or UE's capability signaling(s). Furthermore, the (value of) time window could be (1) determined according to/based on fixed rule(s)/value(s) in system specification(s)—e.g., one or more slots/one or more symbols, (2) configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further sent to the network, e.g., in/via part of a/the CSI/beam report and/or UE's capability signaling(s).

Furthermore, throughout the present disclosure, a UE can be provided, by schedulingRequestID-BeamReporting, a configuration for PUCCH transmission with a UE-initiated TCI state(s)/beam(s) reporting and/or P/SP/AP CSI-RS(s) measurement and reporting request (BRR) for the UE to transmit PUCCH. In addition, a UE can be provided, by schedulingRequestID-BeamActivation, a configuration for PUCCH transmission with a UE-initiated TCI state(s)/beam(s) activation/deactivation/sub-selection request (BAR) for the UE to transmit PUCCH. Furthermore, a UE can be provided, by schedulingRequestID-BeamSwitching, a configuration for PUCCH transmission with a UE-initiated TCI state(s)/beam(s) update/switching/change request (BSR) for the UE to transmit PUCCH. If the UE provides their capabilities of supporting K>1 (e.g., K=2 or K=3) SRs/SR configurations/SR settings, the UE can be provided by schedulingRequestID-BeamReporting a first configuration for PUCCH transmission with a BRR, schedulingRequestID-BeamReporting2 a second configuration for PUCCH transmission with a BRR, and so on, and schedulingRequestID-BeamReportingK a K-th configuration for PUCCH transmission with a BRR. In addition, if the UE provides their capabilities of supporting K>1 (e.g., K=2 or K=3) SRs/SR configurations/SR settings, the UE can be provided by schedulingRequestID-BeamActivation a first configuration for PUCCH transmission with a BAR, schedulingRequestID-BeamActivation2 a second configuration for PUCCH transmission with a BAR, and so on, and schedulingRequestID-BeamActivationK a K-th configuration for PUCCH transmission with a BAR. Furthermore, if the UE provides their capabilities of supporting K>1 (e.g., K=2 or K=3) SRs/SR configurations/SR settings, the UE can be provided by schedulingRequestID-BeamSwitching a first configuration for PUCCH transmission with a BSR, schedulingRequestID-BeamSwitching2 a second configuration for PUCCH transmission with a BSR, and so on, and schedulingRequestID-BeamSwitchingK a K-th configuration for PUCCH transmission with a BSR. Optionally, if the UE provides their capabilities of supporting K>1 (e.g., K=2 or K=3) SRs/SR configurations/SR settings, the UE can be provided by schedulingRequestID-BeamReporting's one or more configurations for PUCCH transmission(s) each with a BRR, and/or schedulingRequestID-BeamActivation's one or more configurations for PUCCH transmission(s) each with a BRR, and/or schedulingRequestID-BeamSwitching's one or more configurations for PUCCH transmission(s) each with a BRR. A PUCCH with the BRR and/or BAR and/or BSR as specified herein in the present disclosure can be transmitted on PCell(s) or PSCell(s) or SCell(s). The total UE transmit power in a symbol of a slot is defined as the sum of the linear values of UE transmit powers for PUSCH, PUCCH, PRACH, and SRS in the symbol of the slot.
PRACH transmission on the PCell
PUCCH or PUSCH transmissions with larger priority index
For PUCCH or PUSCH transmissions with same priority index
PUCCH transmission with HARQ-ACK information, and/or SR, and/or link recovery request (LRR), and/or BRR and/or BAR and/or BSR as specified herein in the present disclosure, or PUSCH transmission with HARQ-ACK information of the priority index.
PUCCH transmission with CSI or PUSCH transmission with CSI.
PUSCH transmission without HARQ-ACK information of the priority index or CSI and, for Type-2 random access procedure, PUSCH transmission on the PCell
SRS transmission, with aperiodic SRS having higher priority than semi-persistent and/or periodic SRS, or PRACH transmission on a serving cell other than the PCell.

Uplink control information (UCI) types reported in a PUCCH include HARQ-ACK information, SR, LRR, SR(s) as specified herein in the present disclosure such as BRR and/or BAR and/or BSR, and CSI. UCI bits include HARQ-ACK information bits, if any, SR information bits, if any, LRR information bits, if any, information bits of the SR(s) as specified herein in the present disclosure such as BRR information bits (if any) and/or BRR information bits (if any) and/or BAR information bits (if any) and/or BSR information bits (if any), and CSI bits, if any. Furthermore, the PUCCH transmission(s) as specified herein in the present disclosure, e.g., in which SR configuration(s) as specified herein in the present disclosure including BRR configuration(s) and/or BAR configuration(s) and/or BSR configuration(s) could be provided, could use PUCCH format 0 and/or PUCCH format 1. As BRR and/or BAR and/or BSR as specified herein in the present disclosure are SR(s) in essence, any reference to SR and/or LRR in the TS 38.213 is applicable for BRR and/or BAR and/or BSR as well.

Throughout the present disclosure, the content(s)/report(s) or content(s) of the report(s) associated/corresponding to a/the SR(s) could comprise/include/contain/provide/indicate one or more of:
Beam reporting-related content(s)/report(s) and/or P/SP/AP CSI-RS measurement report(s) including/comprising/containing one or more of: one or more resource indicators including SSBRI(s) and/or CRI(s), one or more beam metrics including L1-RSRP(s) and/or L1-SINR(s), one or more groups of resource indicators such as SSBRI(s) and/or CRI(s), one or more groups of beam metrics such as L1-RSRP(s)/L1-SINR(s)
Beam activation/indication/switching-related content(s)/report(s) including/comprising/containing one or more of:
   An identity (ID) of the TCI state
   An index/ID of a higher layer RRC configured list/set/pool of TCI states that comprises/indicates/provides the TCI state
   An index of the TCI state in a list/set/pool of TCI states higher layer RRC configured to the UE
   An index of the TCI state in a set of TCI states activated by a (unified) TCI state(s) activation/deactivation MAC CE
   An index/ID of a set of TCI states—e.g., among sets of TCI states activated/provided by a (unified) TCI state(s) activation/deactivation MAC CE—that comprises/indicates/provides the TCI state
   An index of the TCI state among TCI states mapped to a TCI codepoint activated/provided by a (unified) TCI state(s) activation/deactivation MAC CE
   A TCI codepoint activated/provided by a (unified) TCI state(s) activation/deactivation MAC CE that comprises/indicates/provides the TCI state
   An index/ID of a TCI codepoint—e.g., among TCI codepoints activated/provided by a (unified) TCI state(s) activation/deactivation MAC CE—that comprises/indicates/provides the TCI state
   An index of the TCI state among TCI states indicated by a TCI codepoint of a TCI field in a beam indication DCI (e.g., DCI format 1_1/1_2 with or without DL assignment)
   An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
   An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
   An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
   RS index(es)/ID(s) such as SSB index(es)/ID(s) and/or CSI-RS resource index(es)/ID(s) provided/indicated in the TCI state along with the corresponding QCL-type(s)
   Resource indicator(s) such as SSBRI(s) and/or CRI(s) reported in one or more CSI/beam reports
   Beam metric(s) such as L1-RSRP(s) and/or L1-SINR(s) reported in one or more CSI/beam reports
   Index(es)/ordering(s) of resource indicator(s) such as SSBRI(s) and/or CRI(s) among resource indicators such as SSBRIs and/or CRIs reported in one or more CSI/beam reports
   Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
   Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
   Index(es)/ordering(s) of beam metric(s) such as L1-RSRP(s) and/or L1-SINR(s) among beam metrics such as L1-RSRPs and/or L1-SINRs reported in one or more beam/CSI reports
   Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
   Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure-reported in one or more CSI/beam reports
   Group(s)/pair(s) of resource indicators such as SSBRIs and/or CRIs reported in one or more CSI/beam reports
   Index(es)/ordering(s) of group(s)/pair(s) of resource indicators among groups/pairs of resource indicators such as SSBRIs and/or CRIs reported in one or more CSI/beam reports
   Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
   Index(es)/ordering(s) of group(s)/pair(s) of resource indicators among groups/pairs of candidate resource indicators such as SSBRIs and/or CRIs—as specified herein in the present disclosure—reported in one or more CSI/beam reports
   Group(s)/pair(s) of beam metrics such as L1-RSRPs and/or L1-SINRs reported in one or more CSI/beam reports
   Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
   Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
   Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure—reported in one or more CSI/beam reports
   A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.
CSI reporting-related content(s)/report(s) including/comprising/containing one or more of: one or more RIs, one or more PMIs, one or more CQIs, one or more CRIs, and one or more LIs.
TDCP-related content(s)/report(s) including/comprising/containing one or more of: an indicator about the Doppler profile (e.g. Doppler spread or Doppler shift, relative Doppler spreads, or relative Doppler shifts), and an indicator about the auto-correlation profiles (e.g. (auto-)correlation values corresponding to a few dominant lags/delays).

Throughout the present disclosure, for the P/SP/AP CSI-RS(s) measurement and reporting as specified herein in the present disclosure:
The UE could be first configured/activated/triggered/indicated/provided by the network, e.g., via CSI-ResourceConfig, CSI-ReportConfig and/or CSI-AssociatedReportConfigInfo, CSI-AperiodicTriggerState, and/or ‘CSI request’ field in DCI 0_1, one or more P/SP/AP CSI-RS resources to measure
Based on the measurement(s), the UE could be configured/activated/triggered/indicated/provided by the network, e.g., via CSI-ResourceConfig, CSI-ReportConfig and/or CSI-AssociatedReportConfigInfo, to report in one or more CSI reporting instances/CSI reports, one or more groups of resource indicators such as SSBRIs and/or CRIs with each group comprising one or more resource indicators including SSBRIs and/or CRIs, and/or one or more groups of beam metrics such as L1-RSRPs and/or L1-SINRs with each group comprising one or more beam metrics including L1-RSRPs and/or L1-SINRs (each reported group of beam metric(s) could be associated to at least one reported group of resource indicator(s)), one or more indicators indicating one or more CSI resource settings (e.g., in form of their resource setting IDs/indexes) and/or one or more CSI resource sets (e.g., in form of their resource set IDs/indexes) and/or one or more CSI resource groups (e.g., in form of their resource group IDs/indexes) and/or one or more CSI resource pairs (e.g., in form of their resource pair IDs/indexes), and/or etc.
Based on the measurement(s), the UE could be configured/activated/triggered/indicated/provided by the network, e.g., via CSI-ResourceConfig, CSI-ReportConfig and/or CSI-AssociatedReportConfigInfo, to report in one or more CSI reporting instances/CSI reports, one or more RIs, one or more PMIs, one or more CQIs, one or more CRIs, one or more LIs, TDCP-related quantities including one or more indicators about the Doppler profile (e.g. Doppler spread or Doppler shift, relative Doppler spreads, or relative Doppler shifts) and/or one or more indicators about the auto-correlation profiles (e.g. (auto-)correlation values corresponding to a few dominant lags/delays), and/or etc.

Throughout the present disclosure, for TCI state(s)/beam(s) activation/deactivation/sub-selection and/or TCI state(s)/beam(s) switching/change/update as specified herein in the present disclosure:
The UE could receive a MAC CE activation command, used to map up to 8 TCI states and/or pairs of TCI states, with one TCI state for DL channels/signals and/or one TCI state for UL channels/signals to the codepoints of the DCI field ‘Transmission Configuration Indication’ for one or for a set of component carriers (CCs)/DL bandwidth parts (BWPs), and/or up to 8 pairs of TCI states or sets of TCI states, where each set is comprised of one or two TCI state(s) for DL channels/signals and/or one or two TCI state(s) for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the activation command maps TCI-State(s) and/or TCI-UL-State(s) to only one TCI codepoint, the UE could apply the indicated TOI-State(s) and/or TCI-UL-State(s) to one or to a set of CCs/DL BWPs, and if applicable, to one or to a set of CCs/UL BWPs once the indicated mapping for the one single TCI codepoint is applied.
If the UE is configured with SSB-MTC-AdditionalPCI and with PDC CH-Config that contains two different values of coresetPoolIndex in ControlResourceSet, the UE receives a MAC CE activation command for CORESET associated with each coresetPoolIndex, used to map up to 8 TCI states and/or pairs of TCI states, with one TCI state for DL channels/signals and/or one TCI state for UL channels/signals to the codepoints of the DCI field ‘Transmission Configuration Indication’ in one CC/DL BWP. When a set of TCI state IDs are activated for a coresetPoolIndex, the activated TCI states corresponding to one coresetPoolIndex is associated with the serving cell physical cell ID and activated TCI states corresponding to another coresetPoolIndex can be associated with another physical cell ID.
When the UE supports two TCI states in a codepoint of the DCI field ‘Transmission Configuration Indication’ the UE may receive a MAC CE activation command, wherein the MAC CE activation command is used to map up to 8 combinations of one or two TCI states to the codepoints of the DCI field ‘Transmission Configuration Indication’. The UE is not expected to receive more than 8 TCI states in the activation command.

Throughout the present disclosure, for TCI state(s)/beam(s) switching/change/update as specified herein in the present disclosure:
The UE could receive from the network, e.g., via one or more TCI codepoints of one or more TCI fields in one or more beam indication DCIs (e.g., DCI format 1_1/1_2 with or without DL assignment), one or more joint/DL/UL TCI states for at least UE-dedicated reception(s) on PDCCH and/or physical downlink shared channel (PDSCH), dynamic grant/configured grant PUSCH resource(s) and/or each of the dedicated PUCCH resource(s).
In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.
For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.
For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.
For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.
For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0 I/O 2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.
In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework. When a UE is configured with dl-OrJointTCI-StateList or TCI-UL-State and is configured by higher layer parameter PDCCH-Config that contains two different values of coresetPoolIndex in ControlResourceSet, an indicated TCI state is specific to a coresetPoolIndex value, when it is indicated by the DCI field ‘Transmission Configuration Indication’ in DCI format 1_1/1_2 associated with the coresetPoolIndex value.

According to those specified herein in the present disclosure, a UE could identify/determine a list/set/pool of SRs and/or SR IDs and/or SR settings and/or SR setting IDs and/or SR configurations and/or SR configuration IDs and/or etc.—for simplicity, denoted by a list/set/pool of SR setting IDs as specified herein in the present disclosure. The list/set/pool of SR setting IDs could be: (1) determined according to fixed rule(s)/value(s) provided in system specification(s), (2) provided/configured/indicated by the network, e.g., via higher layer RRC signaling(s)/parameter(s) and/or MAC CE command(s) and/or dynamic DCI based L1 signaling(s), and/or (3) autonomously determined by the UE, which could be further sent to the network, e.g., via/in part of a/the CSI/beam report and/or UE's capability signaling(s). Each SR setting ID in the list/set/pool of SR setting IDs could be associated to/with one or more CSI resource configurations and/or one or more CSI reporting configurations as specified herein in the present disclosure.
In one example, the UE (e.g. the UE 116) could indicate to the network (e.g. the network 130) one or more SR setting IDs (and therefore, the corresponding SR(s) and/or SR ID(s)) in the list/set/pool of SR setting IDs. Alternatively, the UE could indicate to the network index(es) of one or more SR setting IDs (and therefore, the corresponding SR(s) and/or SR ID(s)) in the list/set/pool of SR setting IDs.
In another example, the UE could receive from the network a MAC CE activation command activating one or more SR setting IDs from the list/set/pool of SR setting IDs. Alternatively, the UE could indicate to the network that one or more SR setting IDs could be activated from the list/set/pool of SR setting IDs. In this case/design example, the UE could indicate to the network one or more SR setting IDs (and therefore, the corresponding SR(s) and/or SR ID(s)) from the one or more activated SR setting IDs; or the UE could indicate to the network index(es) of one or more SR setting IDs (and therefore, the corresponding SR(s) and/or SR ID(s)) from the one or more activated SR setting IDs.

As specified herein in the present disclosure, with reference to FIG. 8, upon receiving the SR(s) sent by the UE, the network could send to the UE response(s) such as UL grant/acknowledge/etc. for the SR(s). The response(s) for the SR(s) could be in form of one or more aperiodic CSI trigger states indicated/provided by ‘CSI request’ field in the corresponding DCI (e.g., format 0_1). For instance, as specified herein in the present disclosure, one or more SR settings (and therefore, the corresponding SR(s)) could be associated to/with one or more aperiodic trigger states (e.g., via the corresponding CSI reporting/resource configuration(s) as specified herein in the present disclosure). When/if the UE sends/indicates to the network one or more SRs according to those specified herein in the present disclosure, the UE could expect to receive from the network aperiodic CSI trigger state(s) (e.g., indicated via ‘CSI request’ field in DCI format 0_1) associated/corresponding to the one or more SRs as the network's acknowledgement/response to the one or more SRs, within a time window.
In another example, as specified herein in the present disclosure, one or more SR settings (and therefore, the corresponding SR(s)) could be associated to/with one or more aperiodic trigger states (e.g., via the corresponding CSI reporting/resource configuration(s) as specified herein in the present disclosure). In this case/design example, the UE could first receive from the network one or more aperiodic CSI trigger states via ‘CSI request’ field in the corresponding DCI format (e.g., 0_1). The UE could then identify one or more SR settings/SR setting IDs (and therefore, the corresponding SR(s) and/or SR ID(s)), wherein the one or more identified SR settings/SR setting IDs could be associated to/with the received one or more aperiodic CSI trigger states according to those specified herein in the present disclosure. The UE could then indicate to the network one or more SR setting IDs (and therefore, the corresponding SR(s) and/or SR ID(s)) from the one or more identified SR setting IDs; and/or the UE could indicate to the network index(es) of one or more SR setting IDs (and therefore, the corresponding SR(s) and/or SR ID(s)) from the one or more identified SR setting IDs.
In another example, the UE could send to the network one or more SRs and/or SR IDs according to those specified herein in the present disclosure. As specified herein in the present disclosure, the one or more SRs/SR IDs (e.g., via the corresponding SR setting(s) as specified herein in the present disclosure) could be associated to/with one or more CSI resource/reporting configurations according to those specified herein in the present disclosure. For this case/design example, the UE could expect to receive from the network one or more aperiodic CSI trigger states (e.g., indicated/provided by/in the ‘CSI request’ field in DCI format 0_1) associated/corresponding to the same one or more CSI resource/reporting configurations as those associated/corresponding to the one or more SRs/SR IDs.

For the described design examples and/or the design examples specified herein throughout the present disclosure, when/if provided/indicated or upon receiving one or more aperiodic CSI trigger states (e.g., indicated/provided via/in ‘CSI request’ field in the corresponding UL DCI format, e.g., 0_1), the UE could be enabled/allowed/expected to send to the network one or more SRs/SR IDs to trigger/indicate/initiate P/SP/AP CSI-RS(s) measurement and/or reporting, TCI state(s)/beam(s) activation/deactivation/sub-selection and/or TCI state(s)/beam(s) switching/change/update according to those specified herein in the present disclosure, wherein the one or more SRs/SR IDs could be used as trigger/pre-notification message(s) and/or could request UL grant/acknowledgement/etc. for sending content(s)/report(s) corresponding/associated to the one or more SRs/SR IDs over PUSCH/MAC CE and/or PUCCH resource(s). Furthermore, throughout the present disclosure, a CSI-RS resource could correspond to one of: (1) a CSI-RS (resource) for CSI or CSI acquisition, (2) a CSI-RS (resource) for beam management, (3) a tracking reference signal (TRS), (4) a CSI-RS (resource) configured with ‘repetition’ set to ‘on’, (5) a CSI-RS (resource) configured with ‘repetition’ set to ‘off’ and/or etc.

According to those specified herein in the present disclosure, a UE could transmit a SR on a PUCCH resource of a first UL channel to
(Mode A): request UL resource(s)—e.g., DG based PUSCH resource(s)—of a second UL channel to transmit a beam report which could comprise at least one resource indicator such as SSBRI or CRI and/or a corresponding beam metric such as L1-RSRP or L1-SINR; and/or
(Mode B): to notify a transmission of a beam report-comprising at least one resource indicator such as SSBRI or CRI and/or a corresponding beam metric such as L1-RSRP or L1-SINR—on one or more (pre-)configured UL resources of a second UL channel—e.g., Type1 CG PUSCH resource(s)—associated to the SR and/or the PUCCH resource of the first UL channel.

Furthermore, as specified/defined herein in the present disclosure, the SR (and/or the corresponding SR configuration) and/or the PUCCH resource of the first UL channel used to carry/convey the SR could be associated/linked/specific to (e.g., based on or according to network's configuration(s)/indication(s)) one (e.g., Kc=1) or multiple (e.g., Kc>1) first CSI reporting settings each provided by higher layer parameter(s)/signaling(s) CSI-ReportConfig and/or UEI-ReportConfig providing or configuring necessary information/setting(s) for the UEI beam reporting.
For the aforementioned Mode A, after the UE has transmitted the SR on the PUCCH resource of the first UL channel, the UE could expect to receive from the network, e.g., within a time window starting from the first/last symbol or slot of transmitting the SR/the PUCCH resource, a DCI (e.g., of format 0_1/0_2/0_3) in response to the transmission of the SR on the PUCCH resource and/or providing UL grant/assignment for transmitting the beam report. In particular, the DCI could indicate or have a non-zero CSI request field, and a codepoint of the CSI request field could be used to initiate a trigger state,
   When all the bits/codepoints of the CSI request field in the DCI are set to zero, no CSI is requested.
   When the number of configured (CSI) trigger states in CSI-AperiodicTriggerStateList is greater than or equal to 2^{N}^{_{TS}}−1, where N_{TS} is the number of bits of/in the DCI CSI request field, the UE could receive a sub-selection MAC CE command/indication, used to map up to 2^{N}^{_{TS}}−1 trigger states to the bits/codepoints of the CSI request field in the DCI. Here, N_{TS} could be provided or configured by a higher layer parameter reportTriggerSize where N_{TS}∈{1, 2, 3, 4, 5, 6}. When the UE would transmit a PUCCH with HARQ-ACK information in slot n corresponding to the PDSCH carrying the sub-selection MAC CE command/indication, the corresponding action in [10, TS 38.321] and UE assumption on the mapping of the selected CSI trigger state(s) to the codepoint(s)/bit(s) of the CSI request field in the DCI according to or following those specified herein in the present disclosure could be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
When the number of configured (CSI) trigger states in CSI-AperiodicTriggerStateList is less than or equal to 2^{N}^{_{TS}}−1, where N_{TS} is the number of bits of/in the CSI request field, the CSI request field in the DCI can directly indicate the trigger state.
The initiated trigger state could be mapped/linked/associated to one or more second CSI reporting settings each provided by higher layer parameter(s)/signaling(s) CSI-ReportConfig and/or UEI-ReportConfig providing or configuring necessary information/setting(s) for the UEI beam reporting, wherein the one or more second CSI reporting settings could be from or a subset of the e.g. Kc>1 first CSI reporting setting(s) and/or one or more third CSI reporting settings. Furthermore, the UE could determine or identify the aforementioned codepoint of the CSI request field according to or based on:
   Fixe rule(s)/value(s) in system specification(s) and/or per RRC (re-)configuration: for example, the aforementioned codepoint could correspond to the lowest (or highest) codepoint or codepoint 1 (or codepoint 0 or codepoint X) of the CSI request field, wherein X represents the total number of codepoints of the CSI request field; for another example, the aforementioned codepoint could correspond to the x-th lowest (or highest) codepoint or codepoint x of the CSI request field, wherein the value of x is fixed/pre-defined/pre-determined/pre-configured per RRC (re-)configuration and x∈{1, . . . , X} with X representing the total number of codepoints of the CSI request field
   Network's configuration(s)/indication(s), via higher layer RRC e.g., signaling(s)/parameter(s) and/or MAC CE command(s) and/or dynamic DCI based L1 signaling(s) e.g. according to or based on a corresponding UE's capability or capability signaling
In this case, the one or more third CSI reporting settings could be from or a subset of the (e.g., Kc>1) first CSI reporting setting(s) based on or according to one or more of:
   Fixed rule(s) in system specification(s) and/or per RRC (re-)configuration: for example, the third CSI reporting setting(s) could correspond to (or could be identical to/same as) all of the Kc first CSI reporting setting(s); for another example, the third CSI reporting setting(s) could correspond to the first (or second or last) half of the Kc>1 first CSI reporting settings; for another example, e.g., when/if Kc=2, the third CSI reporting setting could correspond to the first (or 1^{st} in order) or the second (or 2^{nd} in order) of the e.g. Kc=2 first CSI reporting settings; for another example, the third CSI reporting setting could correspond to the first CSI reporting setting with the lowest/lower reportConfigId or the first CSI reporting setting with the highest/higher reportConfigId.
   Network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   Indicated by the SR: for example, the SR could be of one-bit with ‘1’ (or ‘0’) or positive (or negative) indicating that the third CSI reporting setting(s) could correspond to the first half of the Kc>1 first CSI reporting settings, and ‘0’ (or ‘1’) or negative (or positive) indicating that the third CSI reporting setting(s) could correspond to the second/last (or first) half of the Kc>1 first CSI reporting settings. For another example, the SR could be of one-bit with ‘1’ (or ‘0’) or positive (or negative) indicating a first bitmap, and ‘0’ (or ‘1’) or negative (or positive) indicating a second bitmap; for this design example, each of the entries/bit positions of the first (and/or second) bitmap could be associated/linked/mapped to a first CSI reporting setting—e.g., the first entry/bit position of the first (and/or second) bitmap could be associated/linked/mapped/corresponding to the first CSI reporting setting with the lowest (or highest) reportConfigId, the second entry/bit position of the first (and/or second) bitmap could be associated/linked/mapped/corresponding to the first CSI reporting setting with the second lowest (or second highest) reportConfigId, and so on, and the last entry/bit position of the first (and/or second) bitmap could be associated/linked/mapped/corresponding to the first CSI reporting setting with the highest (or lowest) reportConfigId; when/if an entry/bit position of the first (or second) bitmap is set to ‘1’ (or ‘0’), the first CSI reporting setting associated, corresponding, specific or mapped to the entry/bit position could correspond to a third CSI reporting setting. For another example, the SR could be of one-bit with ‘1’ (or ‘0’) or positive (or negative) indicating a first set of one or more one-bit indicators, and ‘0’ (or ‘1’) or negative (or positive) indicating a second set of one or more one-bit indicators; for this design example, each of the one-bit indicators in the first (and/or second) set could be associated/linked/mapped to a first CSI reporting setting—e.g., the first (or 1st in order) one-bit indicator in the first (and/or second) set could be associated/linked/mapped/corresponding to the first CSI reporting setting with the lowest (or highest) reportConfigId, the second (or 2^{nd} in order) one-bit indicator in the first (and/or second) set could be associated/linked/mapped/corresponding to the first CSI reporting setting with the second lowest (or second highest) reportConfigId, and so on, and the last (in order) one-bit indicator in the first (and/or second) set could be associated/linked/mapped/corresponding to the first CSI reporting setting with the highest (or lowest) reportConfigId; when/if a one-bit indicator in the first (or second) bitmap is set to ‘1’ (or ‘0’), the first CSI reporting setting associated, corresponding, specific or mapped to the one-bit indicator could correspond to a third CSI reporting setting. For another example, the SR could be a multi-bit or multi-level indicator with each bit/codepoint/level indicating one or more of the first CSI reporting settings as the third CSI reporting setting(s). For another example, e.g., when/if Kc=2, the SR could be of one-bit with ‘1’ (or ‘0’) or positive (or negative) indicating that the third CSI reporting setting could correspond to the first (or 1st in order) of the e.g. Kc=2 first CSI reporting settings or the first CSI reporting setting with the lowest/lower reportConfigId, and with ‘0’ (or ‘1’) or negative (or positive) indicating that the third CSI reporting setting could correspond to the second (or 2^{nd} in order) of the e.g. Kc=2 first CSI reporting settings or the first CSI reporting setting with the highest/higher reportConfigId.
The UE could then identify or determine, based on or according to the second CSI reporting setting(s) and/or the (PDSCH) resource allocation indicator(s)—e.g., the time domain resource assignment (TDRA) indicator—in the corresponding DCI, the beam report(s) and/or the UL resource(s) for transmitting the beam report(s). When/if Kc=1, i.e., the PUCCH resource of the first UL channel that carries the SR is associated to one (or a single) first CSI reporting setting, the UE could then identify or determine, based on or according to the first CSI reporting setting and/or the (PDSCH) resource allocation indicator(s)—e.g., the time domain resource assignment (TDRA) indicator—in the corresponding DCI, the UL resource(s) of the second UL channel for transmitting the beam report; i.e., in this case, the UE may ignore the CSI request field in the DCI. If the number of the second CSI reporting settings is greater than one (e.g., Lc>1) with each of them corresponding to/generating one beam report (i.e., Lc>1 beam reports),
   In one example, the UE could transmit or send, in a single (CSI) reporting instance/CSI-Report, report quantities of the Lc>1 beam reports. For example, the order(s) or position(s) of the report quantities of the Lc>1 beam reports in the (CSI) reporting instance/CSI-Report could be based on or according to the order(s) of the CSI reporting setting ID(s)—each provided by reportConfigId—of their corresponding/respective second CSI reporting settings from low to high (or from high to low). For another example, the (single) CSI report could comprise or one or more CSI (report) fields in the (single) CSI report could convey/carry reportConfigId's of the second CSI reporting settings; in this case, the report quantity(s) of the beam report associated to a second CSI report setting could be carried or comprised or conveyed in one or more CSI (report) fields in the CSI report that follow the CSI (report) field that carries or conveys reportConfigId of the second CSI reporting setting—e.g., starting from the first (in order) CSI (report) field or the CSI (report) field with the lowest/highest index/ID after the CSI (report) field that carries or conveys the reportConfigId, and consecutively with higher or lower CSI (report) field index(es)/ID(s) than that of the CSI (report) field that carries or conveys the corresponding reportConfigId.
   In another example, the UE could transmit or send, in separate or different (e.g., Lc>1) (CSI) reporting instances/CSI-Reports, report quantities of the Lc>1 beam reports. For instance, the UE could send or transmit in the (DG) PUSCH/UL resource(s) or the transmission occasion(s)—e.g., determined or identified based on a second CSI report setting and/or the (PDSCH) resource allocation indicator(s) e.g. the TDRA indicator in the corresponding DCI—to transmit the beam report associated to the second CSI reporting setting.
   In another example, the UE could transmit or send, in a single (CSI) reporting instance/CSI-Report, report quantities of one or more of the Lc>1 beam reports based on or according to their priority index(es)/order(s)—e.g., from high to low. For this design example, the UE could indicate to the network that the UE would transmit or send the report quantities based on or according to priority index(es)/order(s) of their respective beam reports.
For the aforementioned Mode B, after the UE has transmitted the SR on the PUCCH resource of the first UL channel, the UE may not expect to receive from the network, e.g., within a time window starting from the first/last symbol or slot of transmitting the SR/the PUCCH resource, any DCI (e.g., of format 0_1/0_2/0_3) in response to the transmission of the SR on the PUCCH resource and/or providing any UL grant/assignment for transmitting the beam report. In this case, the UE could use and/or apply one or more fourth CSI reporting settings to determine or identify the corresponding beam report(s) and/or UL resource(s) of the second UL channel for carrying or conveying the beam report(s). In particular, the one or more fourth CSI reporting settings could be from or a subset of the e.g. Kc>1 first CSI reporting setting(s) according to or based on one or more of:
   Fixed rule(s) in system specification(s) and/or per RRC (re-)configuration: for example, the fourth CSI reporting setting(s) could correspond to (or could be identical to/same as) all of the Kc first CSI reporting setting(s); for another example, the fourth CSI reporting setting(s) could correspond to the first (or second or last) half of the Kc>1 first CSI reporting settings; for another example, e.g., when/if Kc=2, the fourth CSI reporting setting could correspond to the first (or 1st in order) or the second (or 2^{nd} in order) of the e.g. Kc=2 first CSI reporting settings; for another example, the fourth CSI reporting setting could correspond to the first CSI reporting setting with the lowest/lower reportConfigId or the first CSI reporting setting with the highest/higher reportConfigId.
   Network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling
   Indicated by the SR: for example, the SR could be of one-bit with ‘1’ (or ‘0’) or positive (or negative) indicating that the fourth CSI reporting setting(s) could correspond to the first half of the Kc>1 first CSI reporting settings, and ‘0’ (or ‘1’) or negative (or positive) indicating that the fourth CSI reporting setting(s) could correspond to the second/last (or first) half of the Kc>1 first CSI reporting settings. For another example, the SR could be of one-bit with ‘1’ (or ‘0’) or positive (or negative) indicating a first bitmap, and ‘0’ (or ‘1’) or negative (or positive) indicating a second bitmap; for this design example, each of the entries/bit positions of the first (and/or second) bitmap could be associated/linked/mapped to a first CSI reporting setting—e.g., the first entry/bit position of the first (and/or second) bitmap could be associated/linked/mapped/corresponding to the first CSI reporting setting with the lowest (or highest) reportConfigId, the second entry/bit position of the first (and/or second) bitmap could be associated/linked/mapped/corresponding to the first CSI reporting setting with the second lowest (or second highest) reportConfigId, and so on, and the last entry/bit position of the first (and/or second) bitmap could be associated/linked/mapped/corresponding to the first CSI reporting setting with the highest (or lowest) reportConfigId; when/if an entry/bit position of the first (or second) bitmap is set to ‘1’ (or ‘0’), the first CSI reporting setting associated, corresponding, specific or mapped to the entry/bit position could correspond to a fourth CSI reporting setting. For another example, the SR could be of one-bit with ‘1’ (or ‘0’) or positive (or negative) indicating a first set of one or more one-bit indicators, and ‘0’ (or ‘1’) or negative (or positive) indicating a second set of one or more one-bit indicators; for this design example, each of the one-bit indicators in the first (and/or second) set could be associated/linked/mapped to a first CSI reporting setting—e.g., the first (or 1st in order) one-bit indicator in the first (and/or second) set could be associated/linked/mapped/corresponding to the first CSI reporting setting with the lowest (or highest) reportConfigId, the second (or 2^{nd} in order) one-bit indicator in the first (and/or second) set could be associated/linked/mapped/corresponding to the first CSI reporting setting with the second lowest (or second highest) reportConfigId, and so on, and the last (in order) one-bit indicator in the first (and/or second) set could be associated/linked/mapped/corresponding to the first CSI reporting setting with the highest (or lowest) reportConfigId; when/if a one-bit indicator in the first (or second) bitmap is set to ‘1’ (or ‘0’), the first CSI reporting setting associated, corresponding, specific or mapped to the one-bit indicator could correspond to a fourth CSI reporting setting. For another example, the SR could be a multi-bit or multi-level indicator with each bit/codepoint/level indicating one or more of the first CSI reporting settings as the fourth CSI reporting setting(s). For another example, e.g., when/if Kc=2, the SR could be of one-bit with ‘1’ (or ‘0’) or positive (or negative) indicating that the fourth CSI reporting setting could correspond to the first (or 1st in order) of the e.g. Kc=2 first CSI reporting settings or the first CSI reporting setting with the lowest/lower reportConfigId, and with ‘0’ (or ‘1’) or negative (or positive) indicating that the fourth CSI reporting setting could correspond to the second (or 2^{nd} in order) of the e.g. Kc=2 first CSI reporting settings or the first CSI reporting setting with the highest/higher reportConfigId.
The UE could then identify or determine, based on or according to the fourth CSI reporting setting(s), the beam report(s) and/or the UL resource(s) for transmitting the beam report(s). When/if Kc=1, i.e., the PUCCH resource of the first UL channel that carries the SR is associated to one (or a single) first CSI reporting setting, the UE could then identify or determine, based on or according to the first CSI reporting setting, the beam report(s) and/or the UL resource(s) of the second UL channel for transmitting the beam report(s). If the number of the fourth CSI reporting settings is greater than one (e.g., Lc>1) with each of them corresponding to/generating one beam report (i.e., Lc>1 beam reports),
   In one example, the UE could transmit or send, in a single (CSI) reporting instance/CSI-Report, report quantities of the Lc>1 beam reports. For example, the order(s) or position(s) of the report quantities of the Lc>1 beam reports in the (CSI) reporting instance/CSI-Report could be based on or according to the order(s) of the CSI reporting setting ID(s)—each provided by reportConfigId—of their corresponding/respective fourth CSI reporting settings from low to high (or from high to low). For another example, the (single) CSI report could comprise or one or more CSI (report) fields in the (single) CSI report could convey/carry reportConfigId's of the fourth CSI reporting settings; in this case, the report quantity(s) of the beam report associated to a fourth CSI report setting could be carried or comprised or conveyed in one or more CSI (report) fields in the CSI report that follows the CSI (report) field that carries or conveys reportConfigId of the fourth CSI reporting setting—e.g., starting from the first (in order) CSI (report) field or the CSI (report) field with the lowest/highest index/ID after the CSI (report) field that carries or conveys the reportConfigId, and consecutively with higher or lower CSI (report) field index(es)/ID(s) than that of the CSI (report) field that carries or conveys the corresponding reportConfigId.
   In another example, the UE could transmit or send, in separate or different (e.g., Lc>1) (CSI) reporting instances/CSI-Reports, report quantities of the Lc>1 beam reports. For instance, the UE could send or transmit in a/the first (or 1st in order) Type1 CG PUSCH/UL resource or a/the first (or 1st in order) transmission occasion—e.g., among all the available UL resource(s) of the second UL channel associated to the PUCCH resource of the first UL channel that carries the SR—to transmit the beam report associated to the fourth CSI reporting setting having the lowest (or highest) reportConfigId, in a/the second (or 2^{nd} in order) Type1 CG PUSCH/UL resource or a/the second (or 2^{nd} in order) transmission occasion—e.g., among all the available UL resource(s) of the second UL channel associated to the PUCCH resource of the first UL channel that carries the SR—to transmit the beam report associated to the fourth CSI reporting setting having the second lowest (or second highest) reportConfigId, and so on, and in a/the last (or Lc-th in order) Type-1 CG PUSCH/UL resource or a/the last (or Lc-th in order) transmission occasion—e.g., among all the available UL resource(s) of the second UL channel associated to the PUCCH resource of the first UL channel that carries the SR—to transmit the beam report associated to the fourth CSI reporting setting having the highest (or lowest) reportConfigId.
   In another example, the UE could transmit or send, in a single (CSI) reporting instance/CSI-Report, report quantities of one or more of the Lc>1 beam reports based on or according to their priority index(es)/order(s)—e.g., from high to low. For this design example, the UE could indicate to the network that the UE would transmit or send the report quantities based on or according to priority index(es)/order(s) of their respective beam reports.

Throughout the present disclosure, a beam/CSI report could comprise at least one resource indicator such as SSBRI or CRI and/or a corresponding beam metric such as L1-RSRP or L1-SINR. Furthermore, a beam/CSI report could be associated, specific, mapped or corresponding to a carrier or a component carrier or a cell or a physical cell ID (PCI) in a multi-cell or inter-cell or multi-carrier or cross-carrier operation system. In addition, a beam/CSI report could be associated, specific, mapped, corresponding to detection or declaration or triggering of an event, and different/separate beam/CSI reports could be associated, specific, mapped, corresponding to detection(s) or declaration(s) or triggering(s) of different or separate events or event types.

Throughout the present disclosure, for Mode B, a PUCCH resource of the first UL channel could be could be associated or mapped or linked to one or more Type1 CG PUSCH resources of the second UL channel, wherein the aforementioned association, mapping or linkage could be via network's configuration(s)/indication(s) e.g. via higher layer RRC signaling(s)/parameter(s). After the UE has transmitted or sent the SR on a PUCCH resource of the first UL channel, the UE could identify or determine available UL resource(s) of the second UL channel for transmitting or sending the beam report, wherein the available UL resource(s) of the second UL channel could be from or a subset of the one or more UL resources—e.g., Typ1 CG PUSCH resources—of the second UL channel that are associated, mapped or linked to the PUCCH resource of the first UL channel that carries the SR, and/or the starting symbol/slot/etc. of the available UL resource(s) of the second UL channel could be at least X symbol(s)/slot(s) starting from the first (or last) symbol/slot/etc. of the PUCCH resource of the first UL channel that carries or conveys the SR. The UE could determine or identify the value(s) of X according or based on: (1) fixed value(s) in system specification(s) and/or per RRC (re-)configuration, and/or (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous selection/determination, which could be further sent to the network, e.g., in/via part of a CSI/beam report and/or UE's capability signaling(s).

Throughout the present disclosure, for Mode A and/or Mode B, the UE could be provided or configured by the network, e.g., via higher layer RRC signaling(s)/parameter(s) e.g. SchedulingRequestConfig and/or MAC CE command(s) and/or dynamic DCI based L1 signaling(s) based on or according to a corresponding UE's capability or capability signaling, one or more of the followings for the transmission of the SR in the PUCCH resource of the first UL channel:
schedulingRequestId: used to modify a SR configuration and to indicate, in LogicalChannelConfig, the SR configuration to which a logical channel is mapped and to indicate, in SchedulingRequestresourceConfig, the SR configuration for which a scheduling request resource is used.
sr-ProhibitTimer: Timer for SR transmission in ms on PUCCH
sr-TransMax: Maximum number of SR transmissions

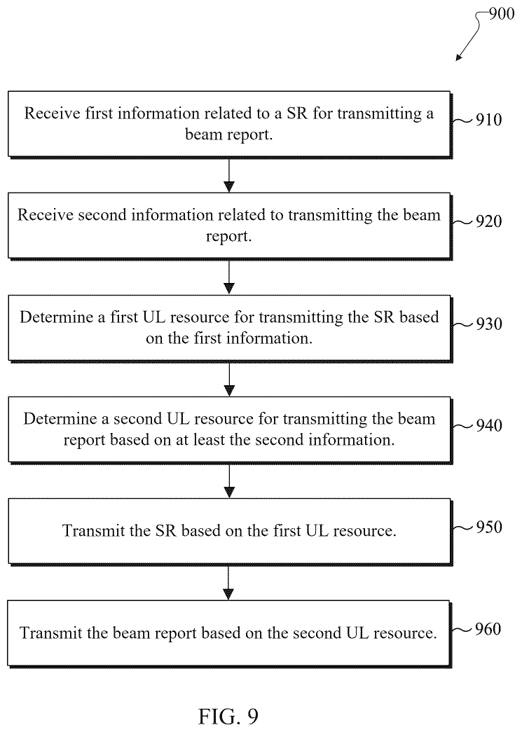

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving first information related to a SR for transmitting a beam report (910). The UE then receives second information related to transmitting the beam report (920). For example, in 920, the second information includes an indicator indicating that the second UL resource is dynamically scheduled or configured by RRC. In various embodiments, the second information includes an association between the SR and a CSI report setting provided by (′SI-ReportConfig.

The UE then determines a first UL resource for transmitting the SR based on the first information (930). For example, in 930, the first UL resource corresponds to a PUCCH resource, and the first information includes at least one of a SR ID provided by a higher layer parameter schedulingRequestId, a resource ID of the PUCCH resource, a periodicity, and an offset for the PUCCH resource.

The UE then determines a second UL resource for transmitting the beam report based on at least the second information (940). For example, in 940, when the second information includes an indicator indicating that the second UL resource is dynamically scheduled, the SR is for requesting at least one UL resource for transmitting the beam report and, when the second information includes an indicator indicating that the second UL resource is configured by RRC, the SR is for notifying transmission of the beam report.

In various embodiments, the second UL resource corresponds to a PUSCH resource, the second information includes a time window, the UE receives, within the time window starting from a last symbol or slot of transmitting the SR, a DCI in response to the SR, and the DCI indicates the second UL resource. In various embodiments, the second UL resource corresponds to a PUSCH resource, and The second information includes a periodicity and an offset for the PUSCH resource and an association between the first UL resource and the second UL resource.

The UE then transmits the SR based on the first UL resource (950). The UE then transmits the beam report based on the second UL resource (960). For example, in 960, the beam report comprises at least one resource indicator corresponding to a SSBRI or a CRI or at least one beam metric corresponding to a L1-RSRP or L1-SINR.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to a scheduling request (SR) for transmission of a beam report; and
receive second information related to transmission of the beam report; and
a processor operably coupled with the transceiver, the processor configured to:
determine, based on the first information, a first uplink (UL) resource for transmitting the SR; and
determine, based on at least the second information, a second UL resource for transmitting the beam report,
wherein the transceiver is further configured to:
transmit, based on the first UL resource, the SR; and
transmit, based on the second UL resource, the beam report, and
wherein the second information includes an indicator indicating that the second UL resource is (i) dynamically scheduled or (ii) configured by radio resource control (RRC).

2. The UE of claim 1, wherein:
the first UL resource corresponds to a physical uplink control channel (PUCCH) resource; and
the first information includes at least one of:
a SR identity (ID) provided by a higher layer parameter schedulingRequestId,
a resource ID of the PUCCH resource,
a periodicity, and
an offset for the PUCCH resource.

3. The UE of claim 1, wherein the beam report comprises:
at least one resource indicator corresponding to a synchronization signal/physical broadcast channel (SS/PBCH) block resource indicator (SSBRI) or a channel state information resource indicator (CRI); or
at least one beam metric corresponding to a layer-1 reference signal received power (L1-RSRP) or a layer-1 signal to interference and noise ratio (L1-SINR).

4. The UE of claim 1, wherein:
when the second information includes an indicator indicating that the second UL resource is dynamically scheduled, the SR is for requesting at least one UL resource for transmitting the beam report; and
when the second information includes an indicator indicating that the second UL resource is configured by RRC, the SR is for notifying transmission of the beam report.

5. The UE of claim 4, wherein:
the second UL resource corresponds to a physical uplink shared channel (PUSCH) resource;
the second information includes a time window;
the transceiver is further configured to receive, within the time window starting from a last symbol or slot of transmitting the SR, a downlink control information (DCI) in response to the SR; and
the DCI indicates the second UL resource.

6. The UE of claim 4, wherein:
the second UL resource corresponds to a physical uplink shared channel (PUSCH) resource; and
the second information includes:
a periodicity and an offset for the PUSCH resource; and
an association between the first UL resource and the second UL resource.

7. The UE of claim 1, wherein the second information includes an association between the SR and a channel state information (CSI) report setting provided by CSI-ReportConfig.

8. A base station, comprising:
a transceiver configured to:
transmit first information related to a scheduling request (SR) for transmission of a beam report; and
transmit second information related to transmission of the beam report; and
a processor operably coupled with the transceiver, the processor configured to:
determine, based on the first information, a first uplink (UL) resource for reception of the SR; and
determine, based on at least the second information, a second UL resource for reception of the beam report,
wherein the transceiver is further configured to:
receive, based on the first UL resource, the SR; and
receive, based on the second UL resource, the beam report, and
wherein the second information includes an indicator indicating that the second UL resource is (i) dynamically scheduled or (ii) configured by radio resource control (RRC).

9. The base station of claim 8, wherein:
the first UL resource corresponds to a physical uplink control channel (PUCCH) resource; and
the first information includes at least one of:
a SR identity (ID) provided by a higher layer parameter schedulingRequestId,
a resource ID of the PUCCH resource,
a periodicity, and
an offset for the PUCCH resource.

10. The base station of claim 8, wherein the beam report comprises:
at least one resource indicator corresponding to a synchronization signal/physical broadcast channel (SS/PBCH) block resource indicator (SSBRI) or a channel state information resource indicator (CRI); or
at least one beam metric corresponding to a layer-1 reference signal received power (L1-RSRP) or a layer-1 signal to interference and noise ratio (L1-SINR).

11. The base station of claim 8, wherein:
when the second information includes an indicator indicating that the second UL resource is dynamically scheduled, the SR is for requesting at least one UL resource for transmission of the beam report; and
when the second information includes an indicator indicating that the second UL resource is configured by RRC, the SR is for notifying transmission of the beam report.

12. The base station of claim 11, wherein:
the second UL resource corresponds to a physical uplink shared channel (PUSCH) resource;
the second information includes a time window;
the transceiver is further configured to transmit, within the time window starting from a last symbol or slot of receiving the SR, a downlink control information (DCI) in response to the SR; and
the DCI indicates the second UL resource.

13. The base station of claim 11, wherein:
the second UL resource corresponds to a physical uplink shared channel (PUSCH) resource; and
the second information includes:
a periodicity and an offset for the PUSCH resource; and
an association between the first UL resource and the second UL resource.

14. The base station of claim 8, wherein the second information includes an association between the SR and a channel state information (CSI) report setting provided by CSI-ReportConfig.

15. A method performed by a user equipment (UE), the method comprising:
receiving first information related to a scheduling request (SR) for transmitting a beam report;
receiving second information related to transmitting the beam report;
determining, based on the first information, a first uplink (UL) resource for transmitting the SR;
determining, based on at least the second information, a second UL resource for transmitting the beam report;
transmitting, based on the first UL resource, the SR; and
transmitting, based on the second UL resource, the beam report,
wherein the second information includes an indicator indicating that the second UL resource is (i) dynamically scheduled or (ii) configured by radio resource control (RRC).

16. The method of claim 15, wherein:
the first UL resource corresponds to a physical uplink control channel (PUCCH) resource; and
the first information includes at least one of:
a SR identity (ID) provided by a higher layer parameter schedulingRequestId,
a resource ID of the PUCCH resource,
a periodicity, and
an offset for the PUCCH resource.

17. The method of claim 15, wherein the beam report comprises:
at least one resource indicator corresponding to a synchronization signal/physical broadcast channel (SS/PBCH) block resource indicator (SSBRI) or a channel state information resource indicator (CRI); or
at least one beam metric corresponding to a layer-1 reference signal received power (L1-RSRP) or a layer-1 signal to interference and noise ratio (L1-SINR).

18. The method of claim 15, wherein:
when the second information includes an indicator indicating that the second UL resource is dynamically scheduled, the SR is for requesting at least one UL resource for transmitting the beam report; and
when the second information includes an indicator indicating that the second UL resource is configured by RRC, the SR is for notifying transmission of the beam report.

19. The method of claim 18, wherein:
the second UL resource corresponds to a physical uplink shared channel (PUSCH) resource;
the second information includes a time window;
the method further comprises receiving, within the time window starting from a last symbol or slot of transmitting the SR, a downlink control information (DCI) in response to the SR; and
the DCI indicates the second UL resource.

20. The method of claim 18, wherein:
the second UL resource corresponds to a physical uplink shared channel (PUSCH) resource; and
the second information includes:
a periodicity and an offset for the PUSCH resource; and
an association between the first UL resource and the second UL resource.
